(19) United States
(12) Patent Application Publication
(10) Pub. No.: US 2025/0255303 A1
(43) Pub. Date: Aug. 14, 2025

(54) FLUXAMETAMIDE COMPOSITION AND PROCESS OF PREPARATION THEREOF

(71) Applicant: RAJDHANI PETROCHEMICALS PRIVATE LIMITED, Ahmedabad, Gujarat (IN)

(72) Inventors: Dipakkumar PATEL, Ahmedabad (IN); Kenal V. SHAH, Ahmedabad (IN); Bhavesh V. SHAH, Ahmedabad (IN); Kawarlal DABODHIA, Ahmedabad (IN)

(73) Assignee: RAJDHANI PETROCHEMICALS PRIVATE LIMITED, Ahmedabad, Gujarat (IN)

(21) Appl. No.: 18/860,099

(22) PCT Filed: Apr. 26, 2023
(86) PCT No.: PCT/IN2023/050407

§ 371 Date: Oct. 25, 2024

(30) Foreign Application Priority Data
Apr. 26, 2022 (IN) 202221024553

(51) Int. Cl. A01N 43/80; A01P 7/04; A01P 21/00

(52) U.S. Cl. CPC A01N 43/80; A01P 7/04; A01P 21/00

(57) ABSTRACT

The present invention relates to fluxametamide composition which offers synergistic control of insect-pests and mites with one shot application, and process of preparation thereof. The present invention more particularly relates to synergistic composition of fluxametamide or its agrochemically acceptable salts thereof, at least one or more compound selected from the group of insecticides, at least one or more compound selected from plant health additives, and agrochemically acceptable excipients; and a process of preparing said composition. The present invention further relates to an insecticidal composition that improves health, yield, vigor, quality and tolerance to abiotic or biotic stress of the treated plant, prevents lodging in susceptible plants due to biotic and abiotic factors, like heavy rains, winds, insects and diseases damage, and gives residual control i.e. longer duration of control with immediate crop protection, as well as effective control of hard to kill and resistant insect-pests and mites.

### FIELD OF INVENTION

The present invention relates to fluxametamide composition and process of preparation thereof. More specifically, the present invention relates to an insecticidal composition comprising bioactive amounts of fluxametamide or its agrochemically acceptable salts thereof, at least one or more compound selected from the group of insecticides, at least one or more compound selected from plant health additives, and agrochemically acceptable excipients; and a process of preparing said composition. The present invention further relates to an insecticidal composition that improves health, yield, vigor, quality and tolerance to abiotic or biotic stress of the treated plant. Moreover, the present invention provides synergistic control of insect-pests and mites with one shot application.

### BACKGROUND OF THE INVENTION

The challenge of growing enough food to feed the world's expanding population, coupled with the changing dietary habits of an expanding middle class throughout Asia, has driven the need to improve crop yield and quality through the control of a wide range of insect pests.

Insecticides are pesticides that are formulated to kill, harm, repel or mitigate one or more species of insect. Insecticides work in different ways. Some insecticides disrupt the nervous system, whereas others may damage their exoskeletons, repel them or control them by some other means. The modes of action of insecticides are classified by the Insecticide Resistance Action Committee (IRAC). In this classification, a large proportion of insecticides are categorized as nerve and muscle targeting insecticides, which encompass GABACl antagonists (Group 2) and GluCl allosteric modulators (Group 6).

The advent of synthetic insecticides in the mid-20th century made the control of insects and other arthropod pests much more effective, and such chemicals remain essential in modern agriculture. By preventing crop losses, raising the quality of produce, and lowering the cost of farming, modern insecticides increased crop yields by as much as 50 percent in some regions of the world in the period 1945-65.

In recent years, one of the novel chemotypes of GABACl antagonists, isoxazolines, have been reported. Isoxazoline is a 5-membered heterocycle present in the active compounds of many commercial veterinary anti-ectoparasitic products. The molecular target of isoxazolines is the inhibition of GABA-gated chloride channels in insects.

However, a major problem with insecticides is the tendency of some target insect populations to develop resistance as their susceptible members are killed off and those resistant strains that survive, multiply eventually perhaps to form a majority of the population. Resistance denotes a formerly susceptible insect population that can no longer be controlled by a pesticide at normally recommended rates. Hundreds of species of harmful insects have acquired resistance to different synthetic organic pesticides, and strains that become resistant to one insecticide may also be resistant to a second that has a similar mode of action to the first. Once resistance has developed, it tends to persist in the absence of the pesticide for varying amounts of time, depending on the type of resistance and the species of pest.

Combination of insecticides are used to broaden the spectrum of control of insects, to improve the pest control with synergistic effect, reduce dosage, thereby reducing environmental impact, to broaden the spectrum of control, decrease chances of resistance development and to enhance residual control so lesser the number of sprays for crop protections and minimizing the pesticidal load in ecosystem.

Because of the problems associated with the heavy use of some chemical insecticides, current insect-control practice combines their use with biological methods in an approach called integrated control. Further combination of insecticides with compounds that benefit the plant is more and more popular with farmers. On the one hand, it can kill insects; on the other hand, it can provide crop nutrients, hence solving the problems of pest control and growth promotion.

Agricultural biostimulants are blends of compounds, substances, and microorganisms that are sprayed on plants or soils to boost crop vigor, yields, quality, and abiotic stress tolerance. Biostimulants promote plant growth and development in a variety of ways throughout the crop life cycle, from seed germination to maturity. Biostimulants function via distinct mechanisms than fertilizers, irrespective of the presence of nutrients in the products. Biostimulants vary from crop protection products due to the fact they act best at the plant's vigor and do not have any direct actions against pests or disease. Crop biostimulation is as a consequence, complementary to crop nutrition and crop protection. Plant growth regulators are defined as small, simple chemicals produced naturally by plants to regulate their growth and development. Plant growth regulators (PGRs) are molecules that influence the development of plants and are generally active at very low concentrations. There are natural regulators, which are produced by the plant itself, and also synthetic regulators; those found naturally in plants are called phytohormones or plant hormones.

CN103102224A relates to an insecticide-fertilizer composition containing benfuracarb, pectin oligosaccharide and a fertilizer component, wherein the fertilizer component contains a macronutrient element and a micronutrient element; the macronutrient element is selected from any one or more of urea, ammonium nitrate, ammonium bicarbonate, potassium chloride, potassium dihydrogen phosphate, sodium dihydrogen phosphate and ammonium phosphate; and the micronutrient element is selected from any one or more of boric acid, borax, manganese sulfate, zinc sulfate, copper sulfate, ammonium molybdate and ferrous sulfate.

CN107512959A relates to a fertilizer special for bletilla tissue culture seedling domestication for preventing and controlling underground insect attack, a preparation method and an application thereof. The fertilizer is prepared from the following raw materials in parts by weight: 10-20 parts of radix sophorae flavescentis, 20-30 parts of chinaberry seeds, 5-10 parts of potassium humate, 15-20 parts of oil tea cake, 1-5 parts of plant growth regulator, 80-120 parts of sheep manure, 100-150 parts of silkworm excrement and 5-10 parts of biological fermentation bacteria.

CN1478761A relates to a multifunctional fertilizer, which comprises a trace element, an insecticide, a long acting agent, a biological agent, a plant growth promoter, and a plant growth regulator, wherein the trace element may be: zinc sulfate, manganese sulfate, ferrous sulfate, magnesium sulfate, copper sulfate, boric acid or borax, ammonium molybdate, silicon powder, and plant growth promoter may be vitamin B1, vitamin B6, nicotinamide or gibberellin.

There is however a need for improvement of these combinations. There is a need in the art for a combination that decreases chances of resistance, improves the spectrum of disease and pest control, and also improves health, yield, vigor, quality and tolerance to abiotic or biotic stress of the treated plant.

### OBJECT OF THE INVENTION

The principal object of the present invention is to provide fluxametamide composition which offers synergistic control of insect-pests and mites with one shot application, and process of preparation thereof.

Another object of the present invention is to provide fluxametamide composition comprising bioactive amounts of fluxametamide or its agrochemically acceptable salts thereof, at least one or more compound selected from the group of insecticides, at least one or more compound selected from plant health additives, and agrochemically acceptable excipients; and a process of preparing said composition.

Another object of the present invention is to provide fluxametamide composition that gives residual control i.e. longer duration of control with immediate crop protection.

Yet another object of the present invention is to provide fluxametamide composition which causes delay in development of resistance and offers effective control of hard to kill and resistant insect-pests and mites.

Yet another object of the present invention is to provide fluxametamide composition that leads to increase in yield of treated plants (cereals, pulses, oilseeds, fibre crop, sugar crops, leafy vegetables, tuber crops, fruit crops, flowers, ornamentals etc.).

Yet another object of the present invention is to provide fluxametamide composition that leads to increase in yield due to protection against insect-pests and mites.

Yet another object of the present invention is to provide fluxametamide composition that leads to increase in yield due to plant growth regulation, and increase in reproductive parts of plant.

Yet another object of the present invention is to provide fluxametamide composition that leads to increase in yield due to more number of tillers, more branches and sub branches, more number of flowers, and more number of fruits.

Yet another object of the present invention is to provide fluxametamide composition that increases plant vigor.

Yet another object of the present invention is to provide fluxametamide composition that increases tolerance to insect-pests and mite damage.

Yet another object of the present invention is to provide fluxametamide composition that increases tolerance to the weather stress and moisture stress.

Yet another object of the present invention is to provide fluxametamide composition that prevents lodging in susceptible plants due to biotic and abiotic factors, like heavy rains, winds, insects and diseases damage.

Yet another object of the present invention is to provide fluxametamide composition that improves quality (means visual appearance, color, size, shape etc.) in grains, fruits, fiber, flowers, tuber, bulb, rhizomes, straw, leaves and other plant parts and plant products.

Yet another object of the present invention is to provide fluxametamide composition that improves keeping quality of produce, increase post harvest life, storage life, and protection from post harvest diseases.

Further object of the present invention is to provide fluxametamide composition that aids uniform sizing in tuber, bulb, rhizome and root crops.

Further object of the present invention is to provide a process of preparing a stable and non-phytotoxic formulation.

### SUMMARY OF THE INVENTION

The present invention provides a synergistic insecticidal composition comprising bioactive amounts of (A) fluxametamide or its agrochemically acceptable salts thereof, (B) at least one or more compound selected from the group of insecticides, (C) at least one or more compound selected from plant health additives, and agrochemically acceptable excipients; and a process of preparing said composition.

The formulation for the insecticidal composition is selected from Capsule suspension (CS), Emulsifiable concentrate (EC), Emulsion, water in oil (EO), Emulsion, oil in water (EW), Jambo balls or bags (bags in water soluble pouch), Micro-emulsion (ME), Oil dispersion (OD), Oil miscible flowable concentrate (oil miscible suspension (OF), Oil miscible liquid (OL), Suspension concentrate (SC), Suspo-emulsion (SE), Soluble concentrate (SL), Wettable granule/Water dispersible granule (WG/WDG), Water soluble granule (SG), Water soluble powder (SP), Wettable powder (WP), A mixed formulation of CS and SC (ZC), A mixed formulation of CS and SE (ZE), a mixed formulation of CS and EW (ZW), Granule (GR)/Soil Applied Granules (SAG), Controlled release granules (CR).

The process for preparing the present novel synergistic composition can be modified accordingly by any person skilled in the art based on the knowledge of the manufacturing the formulation. However, all such variation and modification is still covered by the scope of present invention.

The present invention provides fluxametamide composition which offers synergistic control of insect-pests and mites with one shot application. Further, the composition of the present invention improves health, yield, vigor, quality and tolerance to abiotic or biotic stress of the treated plant, and prevents lodging in susceptible plants due to biotic and abiotic factors, like heavy rains, winds, insects and diseases damage. Moreover, the present invention gives residual control i.e. longer duration of control with immediate crop protection, as well as effective control of hard to kill and resistant insect-pests and mites.

### DETAILED DESCRIPTION OF THE INVENTION

Before explaining the present invention in detail, it is to be understood that the invention is not limited in its application to the details of the parts illustrated. The invention is capable of other embodiments, as described above and of being practiced or carried out in a variety of ways. It is to be understood that the phraseology and terminology employed herein is for the purpose of description and not to limitation. The invention can have various embodiments and they can be performed as described in the following pages of the complete specification.

The terms and words used in the following description are not limited to the bibliographical meanings, but, are merely used by the inventors to enable a clear and consistent understanding of the invention. Accordingly, it should be apparent to those skilled in the art that the following description of exemplary embodiments of the present invention are provided for illustration purpose only and not for the purpose of limiting the scope of the invention.

It is to be understood that the singular forms “a,” “an,” and “the” include plural reference unless the context clearly dictates otherwise.

Features that are described and/or illustrated with respect to one embodiment can be used in the same way or in a similar way in one or more other embodiments and/or in combination with or instead of the features of the other embodiments.

It should be emphasized that the term “comprises/comprising” when used in this specification is taken to specify the presence of stated features, steps or components but does not preclude the presence or addition of one or more other features, steps, components or groups thereof.

The term ‘plants’ as used herein, refers to all physical parts of a plant, including seeds, seedlings, saplings, roots, tubers, stems, stalks, foliage and fruits. The term “plant” is to be understood as including wild type plants and plants, which have been modified by either conventional breeding, or mutagenesis or genetic engineering, or by a combination thereof.

The term “crop” refers to both, growing and harvested crops.

The term “insects” as used herein, includes all organisms in the class “Insecta.”

The term “animal pest” includes arthropods, gastropods, and nematodes. Preferred animal pests according to the invention are arthropods, preferably insects and arachnids, in particular insects. Insects, which are of particular relevance for crops, are typically referred to as crop insect pests.

The term “Insecticidal” as used herein, refers to the ability of a insecticide to increase mortality or inhibit growth rate of insects.

To “control” or “controlling” pests means to inhibit, through a toxic effect, the ability of pests to survive, grow, feed, and/or reproduce, or to limit pest related damage or loss in crop plants. To “control” pests can or can not mean killing the pests, although it preferably means killing the pests.

The term “health of a plant” or “plant health” is defined as a condition of the plant and/or its products. As a result of the improved health, yield, plant vigor, quality and tolerance to abiotic or biotic stress are increased.

“Yield” is to be understood as any plant product of economic value that is produced by the plant such as grains, fruits in the proper sense, vegetables, nuts, grains, seeds, wood (e.g. in the case of silviculture plants) or even flowers (e.g. in the case of gardening plants, ornamentals).

“Increased yield” of a plant, in particular of an agricultural, silvicultural and/or horticultural plant means that the yield of a product of the respective plant is increased by a measurable amount over the yield of the same product of the plant produced under the same conditions, but without the application of the composition according to the invention.

The present invention provides a synergistic insecticidal composition comprising
1. Compound A—fluxametamide or its agrochemically acceptable salts thereof,
2. Compound B—at least one or more compound selected from the group of insecticides,
3. Compound C—at least one or more compound selected from plant health additives,
   with the following mass percentage of the composition:

| Sr. No. | Ingredient | Concentration range (% w/w) |
|---|---|---|
| 1. | Compound A | 1 to 40 |
| 2. | Compound B | 1 to 40 |
| 3. | Compound C | 0.001 to 20 |

Fluxametamide, 4-((5RS)-5-(3,5-dichlorophenyl)-4,5-dihydro-5-(trifluoromethyl) isoxazol-3-yl)-N-((EZ)-(methoxyimino)methyl)-o-toluamide is a novel wide-spectrum insecticide that was discovered and synthesized by Nissan Chemical Industries, Ltd. It belongs to a class of compounds called isoxazolines, which are potent inhibitors of γ-aminobutyric acid (GABA), glutamate-, and glycine-gated chloride channels in insects, and exhibit high insecticidal activity against a variety of insect species, such as Lepidoptera, Thysanoptera, Acarina, and Diptera.

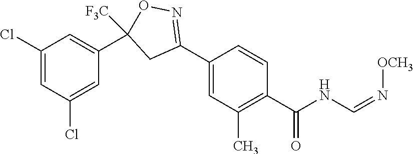 [SMILES: CO/N=C\NC(=O)c1ccc(C2=NOC(c3cc(Cl)cc(Cl)c3)(C(F)(F)F)C2)cc1C]

Fluxametamide is a wide-spectrum isoxazoline insecticide effective against a broad spectrum of pests. It is mainly used in the control of lepidopteran pests, thrips, whiteflies, leaf miners, beetles and mites on crops such as fruit trees, vegetables, soybeans, cotton and tea trees and other crops.

Insecticide(s) for Compound B from the class of carbamates (AChE-acetylcholine esterase inhibitors) is selected from carbaryl, carbofuran, carbosulfan, methomyl, oxamyl, pirimicarb, and thiodicarb; from the class of organophosphates (AChE-acetylcholine esterase inhibitors) is selected from acephate, cadusafos, chlorpyrifos, chlorpyrifos-methyl, demeton-S-methyl, dimethoate, ethion, fenamiphos, fenitrothion, fenthion, fosthiazate, methamidophos, monocrotophos, oxydemeton-methyl, parathion, parathion-methyl, phenthoate, phorate, phosalone, phosphamidon, profenofos, quinalphos, and triazophos; from the class of phenylpyrazoles-fiproles (GABA-gated chloride channel blockers) is selected from ethiprole, fipronil, flufiprole, nicofluprole, pyrafluprole, and pyriprole; from the class of pyrethroids (sodium channel modulators) is selected from bifenthrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, fenpropathrin, fenvalerate, tau-fluvalinate, permethrin, phenothrin, prallethrin, profluthrin, and pyrethrin (pyrethrum); from the class of nicotinic insecticides (nicotinic acteylcholine receptor (nAChR) competitive modulators) is selected from acetamiprid, clothianidin, dinotefuran, imidacloprid, nitenpyram, thiacloprid, thiamethoxam, flupyrimin, cycloxaprid, paichongding, guadipyr, cycloxylidin; sulfoximines-sulfoxaflor; butenolides-flupyradifurone; mesoionics-triflumezopyrim, dichloromezotiaz, and fenmezoditiaz; from the class of nereistoxin analogues (nicotinic acetylcholine receptor (nAChR) channel blockers) is selected from bensultap, monosultap, cartap hydrochloride, thiocyclam, thiocyclam hydrogen oxalate, thiocyclam hydrochloride, and thiosultap sodium; from the class of spinosyns (nicotinic acteylcholine receptor (nAChR) allosteric modulators-Site I) is selected from spinosad, and spinetoram; from the class of avermectins and milbemycins (glutamate-gated chloride channel (GluCl) allosteric modulators) is selected from avermectins-abamectin, emamectin benzoate, ivermectin, lepimectin; and milbemycins-milbemectin; from the class of juvenile hormone mimics is selected from hydroprene, kinoprene, methoprene, fenoxycarb, and pyriproxyfen; from the class of non-specific multi-site inhibitors is selected from chloropicrin, dazomet, and metam; from the class of chordotonal organs modulators is selected from pymetrozine, pyrifluquinazon, afidopyropen, and flonicamid; from the class of mite growth inhibitors affecting CHS1 is selected from clofentezine, hexythiazox, diflovidazin or etoxazole; from the class of benzoylureas (inhibitors of the chitin biosynthesis affecting CHS1 is selected from bistrifluron, chlorfluazuron, diflubenzuron, flucycloxuron, flufenoxuron, hexaflumuron, lufenuron, novaluron, noviflumuron, teflubenzuron, and triflumuron; from the class of buprofezin (inhibitors of the chitin biosynthesis type 1) is selected from buprofezin; from the class of cyromazine (moulting disruptors for dipteran) is selected from cyromazine; from the class of microbial disruptors of insect midgut membrane is selected from Bacillus thuringiensis and insecticidal proteins they produce; from the class of uncouplers of oxidative phosphorylation is selected from chlorfenapyr, DNOC, or sulfluramid; from the class of diacylhydrazines (ecdyson receptor agonists) is selected from diacylhydrazines-methoxyfenozide, tebufenozide, halofenozide, fufenozide or chromafenozide; from the class of octopamin receptor agonists is selected from amitraz; from the class of inhibitors of mitochondrial ATP synthase is selected from diafenthiuron, azocyclotin, cyhexatin, fenbutatin oxide, propargite, or tetradifon; from the class of METI (mitochondrial complex I) inhibitors is selected from fenazaquin, fenpyroximate, pyrimidifen, pyridaben, tebufenpyrad, tolfenpyrad, flufenerim, rotenone, fluacrypyrim, and pyriminostrobin; from the class of METI (mitochondrial complex II) inhibitors is selected from cyenopyrafen, cyflumetofen, and pyflubumide; from the class of METI (mitochondrial complex III) inhibitors is selected from hydramethylnon, acequinocyl, fluacrypyrim, bifenazate, and flometoquin; from the class of METI (mitochondrial complex IV) inhibitors is selected from phosphides and cyanides; from the class of voltage-dependent sodium channel blockers is selected from indoxacarb, and metaflumizone; from the class of inhibitors of the lipid synthesis, inhibitors of acetyl CoA carboxylase is selected from spirodiclofen, spiromesifen, spirotetramat, spidoxamat, spiropidion or spirobudifen; from the class of baculoviruses is selected from granuloviruses and nucleopolyhedrosis viruses; from the class of calcium activated potassium channel (KCa₂) modulators is selected from acynonapyr; compounds of unknown or uncertain mode of action is selected from azadirachtin, benzoximate, bromopropylate, benzpyrimoxan, chinomethionat, dicofol, pyridalyl, oxazosulfyl, dimpropyridaz, indazapyroxamet, tiorantraniliprole, acaricidal compounds-fluhexafon, cyetpyrafen, flupentiofenox, acyonapyr, trifluenfuronate, cyclobutrifluram, fluazaindolizine, and tioxazafen.

Plant health additive(s) for Compound C from the group of bio stimulants is selected from humic acid & salt, fulvic acid & salt, amino acid (alanine, arginine, aspartic acid, cysteine, glutamic acid, glycine, histidine, isoleucine, leucine, lysine, methionine, phenylalanine, proline, serine, threonine, tryptophan, tyrosine, valine or mixture thereof), kojic acid, protein hydrolysates, carboxylic acid, jasmonic acid, methyl jasmonate, chitosan, chitin, alginate, cyclodextrin, probenazole, acibenzolar-s-methyl, laminarin, seaweed extract (Ascophyllum nodosum), polyamines, silicic acid & salt-orthosilicic acid (H4Si04), salicylic acid, lactic acid, phenyl lactic acid, fumaric acid, nitrobenzene, stigmasterol, campesterol, brassinolide (homo), forchlorfenuron, triacontanol, nitrophenolate (sodium para-nitrophenolate, ortho-nitrophenolate, sodium-5-nitroguaiacolate or mixture thereof; from the group of plant growth promoters/regulators is selected from Indole acetic acid, Indole butyric acid, alpha-naphthyl acetic acid, kinetin, zeatin, 6-benzylaminopurine, 6-benzyladenine, dipheylurea, thidiazuron, anisiflupurin, aviglycine, prohexadione, prohexadione calcium, trinexapac, trinexapac-ethyl, aminoethoxyvinylglycine (AVG), gibberelline-gibberellic acid (GA₃), abscisic acid, chlorpropham, flumetralin, maleic hydrazide, mepiquat, mepiquat chloride, mepiquat pentaborate, chlormequat, chlormequat chloride, paclobutrazol, uniconazole-P, or mixture thereof; from the group of micronutrients is selected from zinc (zinc sulphate heptahydrate, zinc sulphate mono hydrate, Zn-EDTA, zinc oxide, zinc lactate gluconate, zinc polyflavonoid), ferrous sulphate, copper sulphate, Manganese sulphate, boron (borax-sodium tetraborate, boric acid (H₃BO₃), di-sodium octa borate tetra hydrate (Na₂B₈O₁₃·4H₂O), di-sodium tetra borate penta hydrate, anhydrous borax), and sulphur (elemental sulphur, bentonite sulphur, boronated sulphur or a sulphate and thiosulphate salt) or mixture thereof.

The present invention optionally comprises agrochemically acceptable excipients including, but not limited to, dispersing agents, anti-freezing agent, anti-foam agent, wetting agents, suspension aid and carriers, anti-microbial agent, thickener, colorants, quick coating agent or sticking agents (also referred to as “stickers” or “binders”), polymers, disintegrating agent, oil additive, buffering agent, and solvents.

Surfactants that are used as dispersants have the ability to adsorb strongly onto a particle surface and provide a charged or steric barrier to re-aggregation of particles. The most commonly used surfactants are anionic, non-ionic, or mixtures of the two types. For wettable powder formulations, the most common dispersants are sodium lignosulphonates. For suspension concentrates, very good adsorption and stabilization are obtained using polyelectrolytes, such as sodium naphthalene sulphonate formaldehyde condensates. Tristyryl phenol ethoxylate phosphate esters are also used. Nonionics such as alkyl aryl ethylene oxide condensates and EO-PO block copolymers are sometimes combined with anionics as dispersants for suspension concentrates. In recent years, new types of very high molecular weight polymeric surfactants have been developed as dispersants. These have very long hydrophobic ‘backbones’ and a large number of ethylene oxide chains forming the ‘teeth’ of a ‘comb’ surfactant. These high molecular weight polymers can give very good long-term stability to suspension concentrates because the hydrophobic backbones have many anchoring points onto the particle surfaces. The dispersants used herein include but not limited to sodium lignosulphonates; sodium naphthalene sulphonate formaldehyde condensates; tristyryl phenol ethoxylate phosphate esters; aliphatic c alcohol ethoxylates; alkyl ethoxylates; EO-PO block copolymers; and graft copolymers or mixtures thereof.

Anti-freezing agent as used herein can be selected from the group consisting of polyethylene glycols, methoxy polyethylene glycols, polypropylene glycols, polybutylene glycols, glycerin and ethylene glycol.

Water-based formulations often cause foam during mixing operations in production. In order to reduce the tendency to foam, anti-foam agents are often added either during the production stage or before filling into bottles. Generally, there are two types of anti-foam agents, namely silicones and non-silicones. Silicones are usually aqueous emulsions of dimethyl polysiloxane while the non-silicone anti-foam agents are water-insoluble oils, such as octanol and nonanol, or silica. In both cases, the function of the anti-foam agent is to displace the surfactant from the air-water interface.

The wetting agents used in wettable powder, suspension concentrate, and water-dispersible granule formulations include but not limited to sodium lauryl sulphate; sodium dioctyl sulpho-succinate; alkyl phenol ethoxylates; and aliphatic alcohol ethoxylates or mixtures thereof.

Suspension aid denotes a natural or synthetic, organic or inorganic material with which the active substance is combined in order to facilitate its application to the plant, to the seeds or to the soil. It is generally inert, and it must be agriculturally acceptable, in particular to the plant being treated. The carrier can be solid and is selected from, but not limited to diatomaceous earth, attapulgite or zeolites, dolomite, silica, fly ash, hydrated lime, wheat flour, wood flour, ground wheat straw, cellulose and soy flour, bentonite, kaolin, calcium carbonate, talc, muscovite mica, fused sodium potassium, aluminum silicate, perlite, urea, sulfur-coated urea, isobutylidene diurea, ammonium nitrate, ammonium sulfate, ammonium phosphate, triple super phosphate, phosphoric acid, potassium sulfate, potassium nitrate, potassium metaphosphate, potassium chloride, dipotassium carbonate, potassium oxide and a combination of these; or liquid and is selected from, but not limited to water, toluene, xylene, petroleum ether, vegetable oils, acetone, methyl ethyl ketone, cyclohexanone, acid anhydrides, acetonitrile, acetophenone, amyl acetate, 2-butanone, butylene carbonate, chlorobenzene, cyclohexane, cyclohexanol, alkyl esters of acetic acid, diacetone alcohol, 1,2 dichloropropane, diethanolamine, p-diethylbenzene, diethylene glycol, diethylene glycol abietate, diethylene glycol butyl ether, diethylene glycol ethyl ether, diethylene glycol methyl ether, N,N-dimethylformamide, dimethyl sulfoxide, 1,4-dioxane, dipropylene glycol, dipropylene glycol methyl ether, dipropylene glycol dibenzoate, diproxitol, alkylpyrrolidone, ethyl acetate, 2-ethylhexanol, ethylene carbonate, 1,1,1-trichloroethane, 2-heptanone, alpha-pinene, d-limonene, ethyl lactate, ethylene glycol, ethylene glycol butyl ether, ethylene glycol methyl ether, gamma-butyrolactone, glycerol, glycerol acetate, glycerol diacetate, glycerol triacetate, hexadecane, hexylene glycol, isoamyl acetate, isobornyl acetate, isooctane, isophorone, isopropyl benzene, isopropyl myristate, lactic acid, laurylamine, mesityl oxide, methoxypropanol, methyl isoamyl ketone, methyl isobutyl ketone, methyl laurate, methyl octanoate, methyl oleate, methylene chloride, m-xylene, n-hexane, n-octylamine, octadecanoic acid, octylamine acetate, oleic acid, oleylamine, o-xylene, phenol, polyethylene glycol, propionic acid, propyl lactate, propylene carbonate, propylene glycol, propylene glycol methyl ether, p-xylene, toluene, triethyl phosphate, triethylene glycol, xylene sulfonic acid, paraffin, mineral oil, trichloroethylene, perchloroethylene, ethyl acetate, amyl acetate, butyl acetate, propylene glycol methyl ether, diethylene glycol methyl ether, methanol, ethanol, isopropanol, and alcohols of higher molecular weight, such as amyl alcohol, tetrahydrofurfuryl alcohol, hexanol, octanol, ethylene glycol, propylene glycol, glycerol, N-methyl-2pyrrolidone and the like.

Biocides/microorganisms cause spoilage of formulated products. Therefore, anti-microbial agents are used to eliminate or reduce their effect. Such agents include, but not limited to, propionic acid and its sodium salt; sorbic acid and its sodium or potassium salts; benzoic acid and its sodium salt; p-hydroxy benzoic acid sodium salt; methyl p-hydroxy benzoate; and biocide such as sodium benzoate, 1,2-benzisothiazoline-3-one, 2-methyl-4-isothiazolin-3-one, 5-chloro-2-methyl-4-isothiazolin-3-one, potassium sorbate, parahydroxy benzoates or mixtures thereof.

Thickening, gelling, and anti-settling agents generally fall into two categories, namely water-insoluble particulates and water-soluble polymers. It is possible to produce suspension concentrate formulations using clays and silicas, for example, but not limited to, montmorillonite, e.g. bentonite; magnesium aluminum silicate; and attapulgite. Water-soluble polysaccharides have been used as thickening-gelling agents for many years. The types of polysaccharides most commonly used are natural extracts of seeds and seaweeds are synthetic derivatives of cellulose or mixtures thereof, for example, but not limited to, guar gum, locust bean gum, carrageenan, xanthan gum, alginates, methyl cellulose, sodium carboxymethyl cellulose (SCMC), hydroxyethyl cellulose (HEC) or mixtures thereof. Other types of anti-settling agents are based on modified starches, polyacrylates, polyvinyl alcohol and polyethylene oxide or mixtures.

Suitable colorant is selected from crystal violet, thalocyano dye chlorinated, aerosol green FFB dye, rodamine, azocompound, iron oxide, titan oxide, iron hexacyanoferrate, alizarin- and phthalocyanine colorants.

The quick coating agent can be a conventionally available sticker, for example polyesters, polyamides, poly-carbonates, polyurea and polyurethanes, acrylate polymers and copolymers, styrene copolymers, butadiene copolymers, polysaccharides such as starch and cellulose derivatives, vinylalcohol, vinylacetate and vinylpyrrolidone polymers and copolymers, polyethers, epoxy, phenolic and melamine resins, polyolefins and define copolymers and mixtures thereof. Polymers are selected from acrylate polymers such as poly(methacrylate), poly(ethyl methacrylate), poly(methylmethacrylate), acrylate copoylmers and styrene-acrylic copolymers, poly(styrene-co maleic anhydride), cellulosic polymers such as ethyl cellulose, cellulose acetate, cellulose acetatebutyrate, acetylated mono, di, and triglycerides, poly(vinylpyrrolidone), vinyl acetate polymers and copolymers, poly(alkylene glycol), styrene butadiene copolymers, poly(orthoesters), alkyd resins, and mixtures of two or more of these. Polymers that are biodegradable are also useful in the present invention. As used herein, a polymer is biodegradable if is not water soluble, but is degraded over a period of several weeks when placed in an application environment. Biodegradable polymers are selected from biodegradable polyesters, starch, polylactic acid starch blends, polylactic acid, poly(lactic acid-glycolic acid) copolymers, polydioxanone, cellulose esters, ethyl cellulose, cellulose acetate butyrate, starch esters, starch ester aliphatic polyester blends, modified corn starch, polycaprolactone, poly(namylmethacrylate), wood resin, polyanhydrides, polyvinylalcohol, polyhydroxybutyratevalerate, biodegradable aliphatic polyesters, and polyhydroxybutyrate or mixtures thereof.

Polymers that are biodegradable are also useful in the present invention. As used herein, a polymer is biodegradable if is not water soluble, but is degraded over a period of several weeks when placed in an application environment. Biodegradable polymers are selected from starch, polylactic acid starch blends, polylactic acid, poly(lactic acid-glycolic acid) copolymers, polydioxanone, cellulose esters, ethyl cellulose, cellulose acetate butyrate, starch esters, starch ester aliphatic polyester blends, modified corn starch, poly caprolactone, poly(namylmethacrylate), wood rosin, polyanhydrides, poly vinyl alcohol, poly hydroxyl butyrate valerate, biodegradable aliphatic polyesters, and poly hydroxyl butyrate or mixtures thereof.

Disintegrating agent is selected from, but not limited to citric acid, succinic acid or sodium bicarbonate.

Oil additive is selected from an oil of vegetable origin, for example rapeseed oil, olive oil or sunflower oil, emulsified vegetable oil, or animal origin, such as fish oil or beef tallow; alkyl esters of C₈-C₂₂ fatty acids, such as the methyl derivatives of C₁₂-C₁₈ fatty acids, for example the methyl esters of lauric acid, palmitic acid and oleic acid (methyl laurate, methyl palmitate and methyl oleate, respectively).

Buffering agent as used herein is selected from group consisting of calcium hydroxyapatite, Potassium Dihydrogen Phosphate, Sodium Hydroxide, carbonated apatite, calcium carbonate, sodium bicarbonate, tri-calcium phosphate, calcium phosphates, carbonated calcium phosphates, amine monomers, lactate dehydrogenase and magnesium hydroxide.

The solvent for the formulation of the present invention is selected from, but not limited to, water, water-soluble alcohols and dihydroxy alcohol ethers. The water-soluble alcohol which can be used in the present invention is selected from lower alcohols or water soluble macromolecular alcohols. The term “lower alcohol”, as used herein, represents an alcohol having 1-4 carbon atoms, such as methanol, ethanol, n-propanol, isopropanol, n-butanol, tert-butanol, etc. Macromolecular alcohol is not limited, as long as it can be dissolved in water in a suitable amount range, e.g., polyethylene glycol, sorbitol, glucitol, etc. Suitable dihydroxyalcohol ethers used in the present invention is selected from dihydroxy alcohol alkyl ethers or dihydroxy alcohol aryl ethers. Dihydroxy alcohol alkyl ether includes ethylene glycol methyl ether, diethylene glycol methyl ether, propylene glycol methyl ether, dipropylene glycol methyl ether, ethylene glycol ethyl ether, diethylene glycol ethyl ether, propylene glycol ethyl ether, dipropylene glycol ethyl ether, etc. Dihydroxy alcohol arylethers include ethylene glycol phenyl ether, diethylene glycol phenyl ether, propylene glycol phenyl ether, dipropylene glycol phenyl ether, and the like. Any of the above mentioned solvent can be used either alone or in combination thereof.

However, those skilled in the art will appreciate that it is possible to utilize additional agrochemically acceptable excipients without departing from the scope of the present invention. The agrochemically acceptable excipient can be in the range from 0.1% to 99% of the total weight of the composition.

The amount of a composition according to the invention to be applied, will depend on various factors, such as the subject of the treatment, such as, for example plants, soil or seeds; the type of treatment, such as, for example spraying, dusting or seed dressing; the purpose of the treatment, such as, for example prophylactic or therapeutic disease control; in case of disease control the type of fungi to be controlled or the application time. This amount of the combinations of the present invention to be applied can be readily deduced by a skilled agronomist.

The combination of the present invention is formulated in a manner which suits the specific application. The formulation is selected from Capsule suspension (CS), Emulsifiable concentrate (EC), Emulsion, water in oil (EO), Emulsion, oil in water (EW), Jambo balls or bags (bags in water soluble pouch), Micro-emulsion (ME), Oil dispersion (OD), Oil miscible flowable concentrate (oil miscible suspension (OF), Oil miscible liquid (OL), Suspension concentrate (SC), Suspo-emulsion (SE), Soluble concentrate (SL), Wettable granule/Water dispersible granule (WG/WDG), Water soluble granule (SG), Water soluble powder (SP), Wettable powder (WP), A mixed formulation of CS and SC (ZC), A mixed formulation of CS and SE (ZE), a mixed formulation of CS and EW (ZW), Granule (GR)/Soil Applied Granules (SAG), Controlled release granules (CR).

More particularly, the formulation is selected from oil dispersion granule (WG), emulsifiable concentrate (EC) and (OD), wettable suspensions concentrate (SC).

The inactive excipients used in various formulations are as follows:

### A. Lists of Inactive Excipient Used in the Oil Dispersion (OD) Formulation:

The wetting agent for oil dispersion (OD) is selected from the group consisting of ethylene oxide/propylene oxide block copolymer, polyarylphenyl ether phosphate, ethoxylated fatty alcohol, sodium dioctyl sulfosuccinate, sodium lauryl sulphate, sodium dodecyl benzene sulfonate, alkyldiphenyl sulfonates, sodium isopropyl naphthalene sulfonate, alkylnaphthalene sulfonate or mixture thereof.

The wetting-spreading-penetrating agent for oil dispersion (OD) is selected from the group consisting of organosilicone surfactants trisiloxane ethoxylate, polydimethylsiloxane, polyoxyethylene methyl polysiloxane, polyoxyalkylene methyl polysiloxane, polyether polymethyl siloxane copolymer, heptamethyl trisiloxane, polyalkyleneoxide modified heptamethyl trisiloxane, polyether modified polysiloxane, can or can not be in modified form, can be liquid or powder form or mixture thereof.

The emulsifying agent for oil dispersion (OD) is selected from the group consisting of castor oil ethoxylates, alcohol ethoxylates, fatty acid ethoxylates, sorbitan ester ethoxylates, sulphosuccinate, calcium salts of dodecylbenzene sulphonate, alkylammonium salts of alkylbenzene sulphonate, alkylsulphosuccinate salts, ethylene oxide-propylene oxide block copolymers, ethoxylated alkylamines, ethoxylated alkyl phenols, polyoxyethylene sorbitan monolaurate or mixture thereof.

The dispersing agent for oil dispersion (OD) is selected from the group consisting of alkyl sulfonates, alkyl benzene sulfonates, alkyl aryl sulfonates, alkylphenolalkoxylates, tristyrylphenol ethoxylates, natural or synthetic fatty ethoxylate alcohols, natural or synthetic fatty acid alkoxylates, natural or synthetic fatty alcohols alkoxylates, alkoxylated alcohols, n-butyl alcohol poly glycol ether, block copolymers, ethylene oxide-propylene oxide block copolymers, ethylene oxide-butylene oxide block copolymers, fatty acid-polyalkylene glycol condensates, polyamine-fatty acid condensates, polyester condensates, salts of polyolefin condensates, sodium ligno sulfonate, sodium ploycarboxylate, EO/PO based copolymer, phenol sulfonate, sodium methyl oleoyl taurate, styrene acrylic acid copolymer, propyleneoxide-ethyleneoxide-copolymer, polyethylene glycol 2,4,6-tristyrylphenyl ether, tristyrylphenol-polyglycolether-phosphate, tristyrylphenole with 16 moles EO, tristyrylphenol-polyglycolether-phosphate, oleyl-polyglycolether with ethylene oxide, tallow fattyamine polyethylene oxide, nonylphenol polyglycolether with 9-10 moles ethylene oxide or mixture thereof.

The stabilizer for oil dispersion (OD) is selected from the group consisting of hectorite clay, aluminium magnesium silicate, bentonite clay, silica, attapulgite clay or mixture thereof.

The antifoaming agent for oil dispersion (OD) is selected from the group consisting of silicone oil, silicone compound, C₁₀˜C₂₀ saturated fat acid compounds or C₈˜C₁₀ aliphatic alcohols compound, silicone antifoam emulsion, dimethylsiloxane, polydimethyl siloxane, vegetable oil based antifoam, tallow based fatty acids, polyalkyleneoxide modified polydimethylsiloxane or mixture thereof.

The anti-freezing agent for oil dispersion (OD) is selected from the group consisting of ethylene glycol, propane diols, glycerine or the urea, glycol, monoethylene glycol, diethylene glycol, polypropylene glycol, polyethylene glycol, glycerine, urea, magnesium sulfate heptahydrate, sodium chloride or mixture thereof.

The preservative for oil dispersion (OD) is selected from the group consisting of 1,2-benzisothiazolin-3 (2H)-one, sodium salt, sodium benzoate, 2-bromo-2-nitropropane-1,3-diol, formaldehyde, sodium o-phenylphenate, 5-chloro-2-methyl-4-isothiazolin-3-one and 2-methyl-4-isothiazolin-3-one or mixture thereof.

The solvent for oil dispersion (OD) is selected from the group consisting of as solvent for the present formulation is selected from and not limited to vegetable oil (plant, seed or tree) or it's alkylated or ethoxylated or esterified. The alkylated vegetable oil can be methylated vegetable oil or ethylated vegetable oil. The vegetable oils include olive oil, kapok oil, castor oil, papaya oil, camellia oil, sesame oil, corn oil, rice bran oil, cotton seed oil, soybean oil, groundnut oil, rapeseed-mustard oil, linseed oil, tung oil, sunflower oil, safflower oil, coconut oil. The alkyl ester of vegetable oils, methyl ester, ethyl ester, propyl ester or butyl ester of vegetable oils, methylated seed oil, polyalkyleneoxide modified polydimethylsiloxane alkylphenol ethoxylate, rapeseed oil methyl ester, rapeseed oil ethyl ester, rapeseed oil propyl esters, rapeseed oil butyl esters, soybean oil methyl ester, soybean oil ethyl ester, soybean oil propyl ester, soybean oil butyl ester, castor oil methyl ester, castor oil ethyl ester, castor oil propyl ester, castor oil butyl ester, cotton seed oil methyl ester, cotton seed oil ethyl ester, cotton seed oil butyl ester, cotton seed oil propyl ester, tall oil fatty acids esters-tallow methyl ester, tallow ethyl ester, tallow propyl ester, bio-diesel, mineral oil, aromatic solvents, isoparaffin, base solvent, fatty acid amides, C₁-C₃ amines, alkylamines or alkanolamines with C₆-C₁₈ carboxylic acids, fatty acids, alkyl esters of fatty acids, methyl and ethyl oleate, methyl and ethyl soyate, alkyl benzenes and alkylnaphthalenes, polyalkylene glycol ethers, fatty acid diesters, fatty alkylamides and diamides, dialkylene carbonates, ketones and alcohols. The above oil based carrier/diluting agents can be used as solo or mixture of two or more if desired or mixture thereof.

The cosolvent for oil dispersion (OD) is selected from the group consisting of cyclohexanone, acetophenone, NMP, dimethyl sulfoxide, benzyl alcohol, butanol, N-octanol, N-propanol, 2-ethyl hexanol, tetrahydro furfuryl alcohol, isophorone, fatty acid dimethyl amide, 2-hexylethyl lactate, propylene carbonate or mixture thereof.

More particularly, the present invention also refers to the method of manufacturing of oil dispersion formulation as describing the following steps:

It is to be understood that the below mentioned steps are applicable to all the manufacturing formulation:
Step 1: Assure the cleanliness of all the plant's equipments and acquire an approval by QC dept prior the initiation of the process.
Step 2: Ensure an electrical connection and standardize the weighing balance.

### Manufacturing Process for Oil Dispersion (OD) Formulation:

### Part A-Preparation of the Liquid Premix

Step 1—The vegetable oil or solvent or both are charged into a vessel with an anchor stirrer.
Step 2—The emulsifier(s) and dispersing agent(s) are added under stirring condition until all the ingredients get completely dissolved.

### Part B—Preparation of the Slurry

Step 1—The liquid premix is charged into a second vessel which is equipped with a cooling and heating device of a high shear stirrer.
Step 2—The active ingredients are added and homogenized thoroughly. The mixture is pre-mill and a particle size distribution is achieved by the final milling practised along with a bead mill as required by the specification.

### Part C—Preparation of the Thickener Gel

Step 1—The vegetable/plant/seed oil or solvent is charged to the vessel which is equipped with a high shear stirrer.
Step 2—The thickener(s) is gradually added which is by throughout mixing and maintaining high-shear. The stirring is continued until thoroughly mixed.
Step 3—The thickener activating agent(s) is added under stirring condition.

Further, the gel is allowed to get swell whilst maintaining the mixing.

### Part D-Preparation of the Final Formulation

Step 1—The thickener gel is added and the mixture is dispersed by using a high shear stirrer.
Step 2—The recommended wetting and spreading agent(s) or adjuvant(s) (silicone or non-silicone based) are finally added to this formulation and dispersed by using high shear stirrer.
Step 3—The finished formulation is checked with specification.
Step 4—The material is packed in its required package sizes when approved.

### B. Lists of Inactive Excipient Used in the (Wettable Granule) WG Formulation:

The dispersing agents for wettable granule (WG) are selected from the group consisting of sodium polycarboxylate, sodium polyacrylate, naphthalene sulfonic acid, sodium salt condensates with formaldehyde, polyalcoxylated alkylphenol, naphthalene sulfonic acid formaldehyde condensate, methyl naphthalene-formaldehyde-condensate sodium salt, naphthalene condensates, lignosulfonates, calcium lignosulfonate, lignin sulfonate sodium salt, alkyl naphthalene sulfonate, sodium salt or mixture thereof. The preferred dispersing agent is alkyl naphthalene sulfonate. It provides an excellent wetting, dispersing, hydrotroping and medium to low foaming. It offers acid and base stability, hard water tolerance and high temperature stability.

The wetting agents for wettable granule (WG) are selected from the group consisting of sodium N-methyl-N-oleoyl taurate, alkylated naphthalene sulfonate, sodium salt, mixture of isomers of dibutyl naphthalene sulphonic acid sodium salt, sodium di-isopropyl naphthalene sulphonate, sodium lauryl sulfate, dioctyl sulfate, alkyl naphthalene sulfonates, phosphate esters, sulphosuccinates and non-ionic, tridecyl alcohol ethoxylate, alkyl or alkaryl sulfonates, alkylbenzene sulfonates, alpha olefin sulfonate and alkyl naphthalene sulfonates, ethoxylated or non-ethoxylated alkyl or alkaryl carboxylates, alkyl or alkaryl phosphate esters, alkyl polysaccharide, di or mono alkyl sulfosuccinate derivatives, alpha olefin sulfonates, alkyl naphthalene sulfonates, dialkyl sulphosuccinates, butyl, dibutyl, isopropyl and di-isopropyl naphthalene sulfonate salts, C₁₂alkyl benzene sulfonate or C₁₀-C₁₆ alkyl benzene sulfonate, organosilicons surfactants, trisiloxane ethoxylate, polydimethylsiloxane, polyoxyethylene methyl polysiloxane, polyoxyalkylene methyl polysiloxane, polyether polymethyl siloxane copolymer, trisiloxane heptamethyl, polyalkyleneoxide modified heptamethyl trisiloxane, polyether modified polysiloxane, can or can not be in modified form, can be liquid or powder form or mixture thereof.

The antifoaming agent for wettable granule (WG) is polydimethylsiloxane.

The carrier for wettable granule (WG) is selected from the group consisting of china clay, silica, lactose anhydrous, ammonium sulfate, sodium sulfate anhydrous, corn starch, urea, EDTA, urea formaldehyde resin, diatomaceous earth, kaolin, bentonite, kieselguhr, fuller's earth, attapulgite clay, bole, loess, talc, chalk, dolomite, limestone, lime, calcium carbonate, powdered magnesia, magnesium oxide, magnesium sulphate, sodium chloride, gypsum, calcium sulphate, pyrophyllite, silicates and silica gels; ammonium sulphate, ammonium phosphate, ammonium nitrate and urea; natural products of vegetable origin, grain meals and flours, bark meals, wood meals, nutshell meals and cellulosic powders; and synthetic polymeric materials, ground or powdered plastics and resins, bentonites, zeolites, titanium dioxide, iron oxides and hydroxides, aluminium oxides and hydroxides, or organic materials, bagasse, charcoal, or synthetic organic polymers or mixture thereof.

The humectant for wettable granule (WG) is selected from the group consisting of humic acid, glycerol, lactose, sodium sulphate anhydrous or mixture thereof.

More particularly, the present invention also refers to the method for preparation of wettable granule formulation as describing the following steps:

### Manufacturing Process of Water Dispersible Granule WG/WDG:

Step 1: An exact weight of active ingredients is considered and a required quantity of binder(s) and surfactant(s) are added in the blender and mixed to achieve a complete homogenization.
Step 2: The homogenized mixture is milled to achieve required wet sieve and post blended to attain homogeneity.
Step 3: The above described homogenous material is passed through an extruder for granulation.
Step 4: The granules are transferred through fluid bed dryer to remove excess moisture.
Step 5: The granules are transferred to vibro shifter.
Step 6: The final material is collected from the vibro shifter into drum.
Step 7: The sample is sent to QC for an approval.
Step 8: The material is transferred into the different size of drums when received an approval from QC.

### C. Lists of Inactive Excipient Used in the Emulsifiable Concentrate (EC) Formulation:

The solvent for emulsifiable concentrate (EC) is selected from the group consisting of aromatic hydrocarbon, C-9, toluene, o-, m-, p-xylene, dodecane, n-decane, n-hexane, benzene, ethylbenzene, isopropylbenzene, tert-butylbenzene, naphthalenes, mono- or polyalkyl-substituted naphthalenes, heavy aromatic naphthalene depleted (aromatic 200, 100, 150), n-butanol, N-methyl 2-pyrrolidine, methanol, ethanol, n-propanol, isopropanol, n-butanol, tert-butanolparaffinic hydrocarbons, cyclohexanone, isophorone, ester solvents, methyloleate, dimethylamide, morpholineamide derivatives of C₆-C₁₆ fatty acids, mono-alkylene carbonates, ethylene carbonate, propylene carbonate, butylene carbonates, dimethylsulfoxide (DMSO), 2-ethylhexanol, n-butanol, n-alkylpyrrolidones, fatty acid dimethyl esters, fatty acid esters, dibasic esters, aromatic hydrocarbons aliphatic hydrocarbons, one or more dimethylamides, C₈-dimethylamide, C₁₀-dimethylamide, C₁₂-dimethylamide, ethylene glycol, propylene glycol, polyalkylene glycols, methylpyrrolidinone (NMP); N, N-decanamide; dimethylformamide (DMF); dimethylisosorbide (DMI); isophorone; acetophenone; 1,3-dimethyl-2-imidazolidonone; lactate esters; dimethyl and diethylcarbonates; alcohols, methanol; ethanol; iso-propanol; n-propanol; n-butanol; iso-butanol; and tert-butanol; methyl L-lactate, 2-ethylhexyl L-lactate, ethyl L-lactate, n-butyl L-lactate, octyl phenyl ethoxylates or mixture thereof.

The emulsifier for emulsifiable concentrate (EC) is selected from the group consisting of emulsifiers containing salts of dodecylbenzene sulphonate, Ca-salts or amine salts, and sulphonates of other C₁₁-C₁₆ alkylbenzenes, alkylether sulphates, alkylphenoletherphosphates and ester phosphates; non-ionic surfactants, alkoxylated alcohols and alkylphenols, ethoxylated fatty acids, ethoxylated vegetable oils, ethoxylated castor oil, fatty acid esters, sorbitol, and their ethoxylated derivatives, ethoxylated amines, condensates of glycerol; catanionic emulsifiers, cationic amine, alkylsulphonate or ether sulphonate or ether phosphate, alkoxylated alcohols, alkoxylated alkylphenols, ethoxylated fatty acids, ethoxylated vegetable oils, ethoxylated tristyrylphenol, fatty acid esters of sorbitol and ethoxylated derivatives thereof; ethoxylated amines, condensates of glycerol; sulfonated alkylbenzenes in the range C₁₁-C₁₆ and salts thereof; alkylether sulphates; alkyletherphosphates; alkylphenoletherphosphates; or combinations thereof; salts of phosphate esters of ethoxylated tristyrylphenol; salts of sulphated ethers of ethoxylated tristyrylphenol; or a catanionic system, wherein a cationic amine is present in combination with an alkylsulphonate, an alkylethersulphonate, an ether sulphate, or an ether phosphate, alkyletherphosphate, nonylphenol polyethoxy ethanols, castor oil polyglycol ethers, polyadducts of ethylene oxide and polypropylene, tributyl phenoxy polyethoxy ethanol, octyl phenoxy polyethoxy ethanol, calcium alkyl benzene sulfonate sodium salt, polyarylphenyl anionic ether sulfate-ammonium salt or mixture thereof.

The sticker, surface tension reducer, binder for emulsifiable concentrate (EC) is polyvinylpyrrolidone.

The spreader, sticker, penetrant, surface tension reducer for emulsifiable concentrate (EC) is alkyl polyethylene glycol ether.

The super wetting-spreading-penetrating agent for emulsifiable concentrate (EC) ispolyalkyleneoxide modified heptamethyltrisiloxane.

More particularly, the present invention also refers to the method for preparation of emulsifiable concentrate formulation as describing the following steps:

### Manufacturing Process of Emulsifiable Concentrate EC:

Step 1: The solvent is charged into the vessel and a required quantity of active ingredients are added (slowly and mixed thoroughly till it gets completely dissolved.
Step 2: The emulsifier(s) is added slowly into this premix and homogenised to get a uniform solution.
Step 3: The wetting-spreading-penetrating agent(s) are added and mixed thoroughly to achieve a uniform clear solution and sent it to QC for quality check.

### D. Lists of Inactive Excipients Used in the Suspension Concentrate (SC) Formulation:

The wetting agent for suspension concentrate (SC) is selected from the group consisting of ethylene oxide/propylene oxide block copolymer, polyarylphenyl ether phosphate, polyalkoxylated butyl ether, ethoxylated fatty alcohol, sodium dioctyl sulfosuccinate, sodium lauryl sulfate, sodium dodecyl benzene sulfonate, alkyl diphenyl sulfonates, sodium isopropyl naphthalene sulfonate, alkyl naphthalene sulfonate, organosilicons surfactants, wetting-spreading-penetrating agent trisiloxane ethoxylate, polydimethylsiloxane, polyoxyethylene methyl polysiloxane, polyoxyalkylene methyl polysiloxane, polyether polymethyl siloxane copolymer, heptamethyl trisiloxane, polyalkyleneoxide modified heptamethyl trisiloxane, polyether modified polysiloxane, polyalkyleneoxide modified trisiloxane, polyalkyleneoxide modified polydimethylsiloxane, trisiloxane ethoxylate, polyoxyethylene methyl polysiloxane, polyether polymethyl siloxane copolymer, polyether modified polysiloxane; can or can not be in modified form, can be liquid or powder form or mixture thereof.

The dispersing agent for suspension concentrate (SC) is selected from the group consisting of naphthalenesulfonic acid, sodium salt condensated with formaldehyde, alkylated naphthalene sulfonate, sodium salt, sodium salt of naphthalene sulfonate condensate, sodium ligno sulfonate, sodium polycarboxylate, EO/PO based copolymer, phenol sulfonate, sodium methyl oleoyl taurate, styrene acrylic acid copolymer, propylene oxide-ethylene oxide-copolymer, polyethylene glycol 2,4,6-tristyrylphenyl ether, tristyrylphenol-polyglycol ether-phosphate, tristyrylphenole with 16 moles EO, tristyrylphenol-polyglycol ether-phosphate, oleyl-polyglycol ether with ethylene oxide, tallow fatty amine polyethylene oxide, nonylphenol polyglycol ether with 9-10 moles ethylene oxide or mixture thereof.

The suspending agent for suspension concentrate (SC) is selected from the group consisting of aluminum magnesium silicate, bentonite clay, silica, attapulgite clay or mixture thereof.

The antifoaming agent for suspension concentrate (SC) is selected from the group consisting of silicone oil, silicone compound, C₁₀˜C₂₀ saturated fat acid compounds or C₈˜C₁₀ aliphatic alcohols compound, silicone antifoam emulsion, dimethyl siloxane, polydimethyl siloxane, vegetable oil based antifoam, tallow based fatty acids, polyalkyleneoxide modified polydimethylsiloxane or mixture thereof.

The anti-freezing agent for suspension concentrate (SC) is selected from the group consisting of ethylene glycol, propane diols, glycerin or the urea, glycol, monoethylene glycol, diethylene glycol, polypropylene glycol, polyethylene glycol, glycerin, urea, magnesium sulfate heptahydrate, sodium chloride or mixture thereof.

The preservatives for suspension concentrate (SC) is selected from the group consisting of 1,2-benzisothiazolin-3 (2H)-one, sodium salt, sodium benzoate, 2-bromo-2-nitropropane-1,3-diol, formaldehyde, sodium o-phenyl phenate, 5-chloro-2-methyl-4-isothiazolin-3-one and 2-methyl-4-isothiazolin-3-one or mixture thereof.

The thickeners for suspension concentrate (SC) is selected from the group consisting of xanthan gum, PVK, carboxymethyl celluloses, polyvinyl alcohols, gelatin, sodium carboxymethylcellulose, hydroxyethyl cellulose, sodium polyacrylate, modified starch, acacia gum or mixture thereof.

The humectant for suspension concentrate (SC) is selected from the group consisting of urea, humic acid, glycerol, lactose or mixture thereof.

More particularly, the present invention also refers to the method for preparation of suspension concentrate formulation as describing the following steps:

### Manufacturing Process for Suspension Concentrate (SC) Formulation:

Step 1—Gel preparation: A required quantity of water is charged to a vessel which is equipped with a high shear stirrer whilst the agitation is initiated. A required amount of preservative(s) is added and mixed to form a homogenous mixture. A required amount of thickener(s) is added and mixed vigorously to achieve wetness.
Step 2—A required quantity of water is charged to a vessel which is equipped with a bulk agitator and a high shear homogenizer; initiated the agitation. Further, a required amount of an anti freezing agent(s) is added and mixed to achieve uniformity. Moreover, the antifoaming agent(s) is added whilst ensuring that it is well dispersed. The wetting and dispersing agent(s) are added and mixed to achieve uniformity whilst ensuring that the dispersing agent is fully dispersed.
Step 3—The active ingredients are added and the agitation of the vessel contents are continued until all the components get dissolved. The pre-mix is milled through a colloid mill and subsequently through a dyno mill to meet the specified particle size.
Step 4—The remaining antifoaming agent(s) is added to this SC mill base to a vessel which is equipped with the bulk agitator and mixed to achieve uniformity. The required amount of 2% aqueous pre-gel and suspending agent(s) are added and the agitation is continued until the formulation is homogeneous and has reached the target viscosity.
Step 5—The final product is submitted for QC approval.
Step 6—The material is packed in its required package sizes when received approval.

### EXAMPLES

The present invention has been described with reference to specific embodiment which is merely illustrative and not intended to limit the scope of the invention as defined in the present complete specification.

### Biological Examples

The synergistic pesticide action of the inventive mixtures can be demonstrated by the experiments below. A synergistic effect exists wherever the action of a combination (ready-mix) or tank mix of active ingredient is greater than the sum of the action of each of the components alone. Therefore a synergistically effective amount or an effective amount of a synergistic composition or combination is an amount that exhibits greater pesticide activity than the sum of the pesticide activities of the individual components.

In the field of agriculture, it is often understood that the term “synergy” is as defined by Colby S. R. in an article entitled “Calculation of the synergistic and antagonistic responses of herbicide combinations” published in the journal Weeds, 1967, 15, p.20-22, incorporated herein by reference in its entirety. The action expected for a given combination of two or three active components can be calculated as follows:

$$Colby ’ s formula for calculating synergism between two active ingredients$$

$$E = ( X + Y ) - \frac{( X \text{?} Y )}{100}$$

$$Where , E = Expected / Calculated control by mixture or combination of$$

$$Compound A and Compound B in a defined dose$$

$$X = Control Observed by Compound A \text{?} Y = Control Observed by$$

$$Compound B$$

$$Colby ’ s formula for calculating synergism between three active$$

$$ingredients$$

$$E = ( X + Y + Z ) - \frac{( XY + XZ + YZ )}{100} + \frac{( X Y Z )}{10000}$$

$$Where , E = Expected / Calculated control by mixture or combination of$$

$$Compound A , Compound B and Compound C in a defined dose$$

$$X = Control Observed by Compound A \text{?} Y = Control Observed by$$

$$Compound B \text{?} Z = Control Observed by Compound C$$

$$Colby ’ s Ratio = \frac{Control Observed}{Expected / Calculated control}$$

$$If Colby ’ s ratio > 1 means synergism observed \text{?} < 1 means$$

$$antagonism observed \text{?} = 1 means simple additive effect Higher the$$

$$ratio , means stronger the synergism \text{?} Lower ratio means weak$$

$$synergism$$

$$\text{?} \text{indicates text missing or illegible when filed}$$

The objective of the present studies is to study the synergism and benefits of compositions comprising of fluxametamide, at least at least one insecticide and at least one plant health additive were analyzed.

### Example 1: Bioefficacy Against Chilli Thrips, Fruit Borer and Effect on Yield

Crop: Chilli, Capsicum annuum L.
Location: Bochasan, Gujarat
Number of treatments: 19
Plot size: 44 sq.m. (square meter)
Crop stage: 80 days after transplanting.
Method of application: foliar spray with battery operated back pack
sprayer
Water volume: 500 liter per hectare

### Observation Methods:

Thrips (mixed infestation of Thrips parvispinusis and Scirtothrips dorsalis): Count the number of live thrips by shaking the twigs on black piece of paper. Record the observations from 3 twigs per plant and 10 plants per plot on 7 and 14 DAA (days after application). Calculate thrips control (%) as observed control and apply colby's formula to calculate syngergism.

$$Thrips Control ( \% ) = 100 - \frac{number of live thrips in treatment}{number of live thrips in untreated ( UTC )} \times 100$$

Fruit borer (Helicoverpa armigera) larval control (%): Count the number of live larvae per plant. Record observations from 10 plants per plot on 7th days after application.

$$\% Larval control = 100 - \frac{Number of live larva in treatment}{Number of live larva in untreated control} \times 100$$

Fruit borer larval control (%) data were used to check the synergism by applying Colby's formula given above.

Healthy fruit count: Count the number of healthy fruits per plant. Record the observations from 10 plants per plot, and calculate increase (%) in healthy fruits over UTC (untreated check).

$$Increase ( \% ) in fruits over untreated control = \frac{100 \times Number of fruits in treatment}{Number of fruits in untreated control} - 100$$

T1: Composition of fluxametamide 6% + abamectin
1.8% + gibberellic acid 0.4% EC

| | Percent |
|---|---|
| Chemical composition | (w/w) |
| Fluxametamide a.i. | 6.00 |
| Abamectin a.i. | 1.80 |
| Gibberellic acid a.i. | 0.40 |
| Calcium alkyl benzene sulfonate sodium salt | 8.00 |
| (Emulsifier-1) | |
| Polyarylphenyl anionic ether sulfate, ammonium salt | 7.00 |
| (Emulsifier-2) | |
| Polyalkyleneoxide Modified Heptamethyltrisiloxane | 5.00 |
| (super wetting-spreading-penetrating agent) | |
| N,N-decanamide | 15.00 |
| Aromatic solvent C-9 | 56.80 |
| Total | 100.00 |

a.i. (active ingredient/technical) on 100% purity basis

T1: Storage stability-fluxametamide 6% +
abamectin 1.8% + gibberellic acid 0.4% EC
Laboratory storage stability for 14 days

| | Specification | | At 54 ± | At 0 ± |
|---|---|---|---|---|
| Parameters | (in house) | Initial | 2° C. | 2° C. |
| Fluxametamide a.i. | 5.70 to 6.6 | 6.30 | 6.20 | 6.3 |
| Abamectin a.i. | 1.71 to 1.98 | 1.90 | 1.85 | 1.90 |
| Gibberellic acid a.i. | 0.38 to 0.44 | 0.42 | 0.41 | 0.42 |
| pH range (1% aq. | 5.5 to 8.0 | 7.10 | 7.00 | 7.10 |
| Suspension) | | | | |
| Emulsion stability | 2 ml creaming and | Nil | 0.30 | Nil |
| | 2 ml sediment | | | |
| Specific gravity | 0.90-1.10 | 0.95 | 0.95 | 0.95 |

T1: Room temperature storage stability up to 12 months

| | Specification | | 1 | 6 | 12 |
|---|---|---|---|---|---|
| Parameters | (in house) | Initial | month | month | month |
| Fluxametamide a.i. | 5.70 to 6.6 | 6.3 | 6.30 | 6.30 | 6.3 |
| Abamectin a.i. | 1.71 to 1.98 | 1.9 | 1.90 | 1.90 | 1.90 |
| Gibberellic acid a.i. | 0.38 to 0.44 | 0.42 | 0.42 | 0.42 | 0.42 |
| pH range (1% aq. | 5.5 to 8.0 | 7.10 | 7.10 | 7.10 | 7.08 |
| Suspension) | | | | | |
| Emulsion stability | 2 ml creaming | Nil | Nil | Nil | 0.10 |
| | and 2 ml | | | | |
| | sediment | | | | |
| Specific gravity | 0.90-1.10 | 0.95 | 0.95 | 0.95 | 0.95 |

The composition of fluxametamide 6% + abamectin 1.8% + gibberellic acid 0.4% EC meets the all inhouse specifications for storage stability studies in laboratory (at 54 ± 2° C. and at 0 ± 2° C. for 14 days) and room temperature (for 12 months).

### T1: Manufacturing Process for 100 kg Batch of Fluxametamide 6%+Abamectin 1.8%+Gibberellic Acid 0.4% EC

Step 1:15.0 kg of N,N-decanamide and 56.80 kg of aromatic solvent were added into other vessel having slow stirring. Further, 6.0 kg of fluxametamide (active ingredient), 1.8 kg of abamectin, 0.4 kg of gibberellic acid were added and mixed properly for 30-45 minutes.
Step 2:8.0 kg of calcium alkyl benzene sulfonate sodium salt, 7.0 kg of polyarylphenyl anionic ether sulfate and ammonium salt were added and mixed properly for 30-45 minutes.
Step 3:5.0 kg of polyalkyleneoxide modified heptamethyltrisiloxane was added to this formulation and sent to QC for quality check.

T2: Composition of fluxametamide 3% + tolfenpyrad
12% + gibberellic acid 0.2% SC

| | Percent |
|---|---|
| Chemical composition | (w/w) |
| Fluxametamide a.i. | 3.00 |
| Tolfenpyrad a.i. | 12.00 |
| Gibberellic acid a.i. | 0.20 |
| Polyalkyleneoxide Modified Heptamethyltrisiloxane | 5.00 |
| (super wetting-spreading-penetrating agent) | |
| Acrylic Graft copolymers (dispersing agent I) | 4.50 |
| Sodium salt of polycarboxylate (dispersing agent II) | 1.00 |
| Bentonite clay (suspending agent) | 0.50 |
| Polydimethylsiloxane (anti foaming agent) | 0.30 |
| 1,2-benzisothiazolin-3(2H)-one (preservative) | 0.15 |
| Polyethylene glycols, (anti freezing agent) | 5.00 |
| Xanthan gum (thickner) | 0.15 |
| Diluent water | 68.20 |
| Total | 100.00 |

a.i. (active ingredient) on 100% purity basis

T2: Storage stability-fluxametamide 3% +
tolfenpyrad 12% + gibberellic acid 0.2% SC
Laboratory storage stability for 14 days

| | Specification | | At 54 ± | At 0 ± |
|---|---|---|---|---|
| Parameters | (in house) | Initial | 2° C. | 2° C. |
| Fluxametamide a.i. | 2.85 to 3.3 | 3.30 | 3.15 | 3.3 |
| Tolfenpyrad a.i. | 11.40 to 12.60 | 12.40 | 12.25 | 12.4 |
| Gibberellic acid a.i. | 0.19 to 0.22 | 0.21 | 0.21 | 0.21 |
| Fluxametamide | 80 | 98.50 | 98.50 | 98.30 |
| suspensibility (%) | | | | |
| Tolfenpyrad | 80 | 98.60 | 98.60 | 98.40 |
| suspensibility (%) | | | | |
| Gibberellic | 80 | 98.00 | 98.00 | 97.60 |
| acidsuspensibility (%) | | | | |
| pH range (1% aq. | 5.5 to 8.0 | 7.00 | 7.00 | 7.20 |
| Suspension) | | | | |
| Pourability (%) | 95 | 98.20 | 98.20 | 97.80 |
| Specific gravity | 1.05-1.10 | 1.08 | 1.08 | 1.08 |
| Viscosity at spindle | 350-800 cps | 550 | 550 | 550 |
| no. 62, 20 rpm | | | | |
| Particle size (micron) | D50 < 3, | 2.1, 8.6 | 2.1, 8.6 | 2.1, 8.7 |
| | D90 < 10 | | | |
| Persistent foam ml | 60 | nil | nil | nil |
| (after 1 minute) max. | | | | |

T2: Rom temperature storage stability up to 12 months

| | Specification | | 1 | 6 | 12 |
|---|---|---|---|---|---|
| Parameters | (in house) | Initial | month | month | month |
| Fluxametamide | 2.85 to | 3.30 | 3.30 | 3.3 | 3.25 |
| a.i. (% w/w) | 3.3 | | | | |
| Tolfenpyrad | 11.40 to | 12.40 | 12.40 | 12.4 | 12.35 |
| a.i. (% w/w) | 12.60 | | | | |
| Gibberellic acid | 0.19 to | 0.21 | 0.21 | 0.21 | 0.21 |
| a.i. (% w/w) | 0.22 | | | | |
| Fluxametamide | 80 | 98.50 | 98.50 | 98.30 | 98.30 |
| suspensibility (%) | | | | | |
| Tolfenpyrad | 80 | 98.60 | 98.60 | 98.40 | 98.40 |
| suspensibility (%) | | | | | |
| Gibberellic acidsus- | 80 | 98.00 | 98.00 | 97.60 | 97.60 |
| pensibility (%) | | | | | |
| pH range (1% aq. | 5.5 to | 7.00 | 7.00 | 7.10 | 7.20 |
| Suspension) | 8.0 | | | | |
| Pourability (%) | 95 | 98.20 | 98.20 | 97.80 | 97.80 |
| Specific gravity | 1.05-1.10 | 1.08 | 1.08 | 1.08 | 1.08 |
| Viscosity at spindle | 350-800 cps | 550 | 550 | 550 | 550 |
| no. 62, 20 rpm | | | | | |
| Particle | D50 < 3, | 2.1, 8.6 | 2.1, 8.6 | 2.1, 8.7 | 2.1, 8.7 |
| size (micron) | D90 < 10 | | | | |
| Persistent foam | 60 | nil | nil | nil | nil |
| in ml (after 1 | | | | | |
| minute) max. | | | | | |

The composition of fluxametamide 3% + tolfenpyrad 12% + gibberellic acid 0.2% SC meets the all inhouse specifications for storage stability studies in laboratory (at 54 ± 2° C. and at 0 ± 2° C. for 14 days) and room temperature (for 12 months).

### T2: Manufacturing Process for 100 kg Batch of Fluxametamide 3%+Tolfenpyrad 12%+Gibberellic Acid 0.2% SC

Step 1—Gum solution: xanthan gum (2.0 kg) and 1,2-benzisothiazoline-3-one (2.0 kg) was charged into 96.0 kg water and was homogenized. The abovementioned mixture was prepared 12-18 hours prior its use.
Step 2—DM water (60.7 kg) and 1,2-propylene glycol (5 kg) was charged into designated vessel and mixed thoroughly.
Step 3—A sodium salt of polycarboxylate (1.0 kg), acrylic graft copolymer (4.5 kg) and bentonite clay (0.5 kg) were added into the vessel having water and the contents were homogenized for 45-60 minutes by using the high shear homogeniser.
Step 4—Fluxametamide (3.0 kg), tolfenpyrad (12.0 kg) and gibberellic acid (0.2 kg) were added slowly to this premix and homogenised to achieve uniform slurry, ready for grinding.
Step 5—Half of the quantity of polydimethylsiloxane (0.15 kg) was added before grinding and then the material was subjected for grinding in dyno mill till the desired particle size was achieved.
Step 6—After the completion of the grinding process and before the sampling for in process analysis, the remaining polydimethyl siloxane (0.15 kg) antifoam was added.
Step 7—7.5 kg of 2% xanthum gum solution and 5.0 kg of polyalkyleneoxide modified heptamethyltrisiloxane (super wetting-spreading-penetrating agent) was added to this formulation and homogenized for 30 minutes.
Step 8—The final formulation was sent to QC for quality check.

TABLE 1
Treatment details

| Treat- | | gram actives |
|---|---|---|
| ment | | ingredients |
| Number | Treatment compositions | per hectare |
| T1 | Fluxametamide 6% + Abamectin 1.8% + | 30 + 9 + 2 |
| | GA 0.4% EC | |
| T2 | Fluxametamide 3% + Tolfenpyrad 12% + | 30 + 120 + 2 |
| | GA 0.2% SC | |
| T3 | Fluxametamide 6% + Fipronil 9% + GA 0.4% SC | 30 + 45 + 2 |
| T4 | Fluxametamide 6% + Dimpropyridaz 9% + | 30 + 45 + 2 |
| | GA 0.4% SC | |
| T5 | Fluxametamide 6% + Isocycloseram 6% + | 30 + 30 + 2 |
| | GA 0.4% SC | |
| T6 | Fluxametamide 6% + Abamectin 1.8% EC | 30 + 9 |
| T7 | Fluxametamide 3% + Tolfenpyrad 12% SC | 30 + 120 |
| T8 | Fluxametamide 6% + Fipronil 9% SC | 30 + 45 |
| T9 | Fluxametamide 6% + Dimpropyridaz 9% SC | 30 + 45 |
| T10 | Fluxametamide 6% + Isocycloseram 6% SC | 30 + 30 |
| T11 | Fluxametamide 10% EC + Gibberellic acid | 30 + 2 |
| | 40% WSG (tank mix) | |
| T12 | Fluxametamide 10% EC | 30 |
| T13 | Gibberellic acid (GA) 40% WSG | 2 |
| T14 | Abamectin 1.9% EC | 9 |
| T15 | Tolfenpyrad 15% EC | 120 |
| T16 | Fipronil 5% SC | 45 |
| T17 | Dimpropyridaz 12% SL | 45 |
| T18 | Isocycloseram 10% DC | 30 |
| T19 | Untreated Check (UTC) | — |

GA—gibberellic acid, SC—suspension concentrate, EC—emulsifiable concentrate, WSG—water soluble granule, SL—soluble liquid, DC—dispersion concentrate. T1 to T5 are innovative present compositions, T6 to T10 are known compositions (prior art), T11 on farm tank mix, T12 to T16 are market products, T17 and T18 in house developed formulation for field trial.

TABLE 2a
Thrips control in chilli crop

| | Thrips control (%) | | | | | | | |
|---|---|---|---|---|---|---|---|---|
| | at 7 DAA | | | | at 14 DAA | | | |
| Treatment | control | control | Colby's | Synergism | control | control | Colby's | Synergism |
| Number | observed | expected | ratio | (Y/N) | observed | expected | ratio | (Y/N) |
| T1 | 98.4 | 85.4 | 1.15 | Y | 84.6 | 76.2 | 1.11 | Y |
| T2 | 99.2 | 88.3 | 1.12 | Y | 81.2 | 75.0 | 1.08 | Y |
| T3 | 98.2 | 85.8 | 1.14 | Y | 78.6 | 73.9 | 1.06 | Y |
| T4 | 96.8 | 83.3 | 1.16 | Y | 79.6 | 74.3 | 1.07 | Y |
| T5 | 97.6 | 84.4 | 1.16 | Y | 77.4 | 73.3 | 1.06 | Y |
| T6 | 65.8 | 58.4 | 1.13 | Y | 45.8 | 46.1 | 0.99 | N |
| T7 | 71.4 | 66.8 | 1.07 | Y | 42.6 | 43.5 | 0.98 | N |
| T8 | 65.2 | 59.7 | 1.09 | Y | 39.8 | 40.9 | 0.97 | N |
| T9 | 58.8 | 52.7 | 1.12 | Y | 40.8 | 41.9 | 0.97 | N |
| T10 | 61.2 | 55.7 | 1.10 | Y | 38.6 | 39.5 | 0.98 | N |
| T11 | 67.6 | 66.4 | 1.02 | Y | 53.4 | 56.3 | 0.95 | N |
| T12 | 64.8 | | | | 55.8 | | | |
| T13 | 4.6 | | | | 1.2 | | | |
| T14 | 56.4 | | | | 45.4 | | | |
| T15 | 65.2 | | | | 42.8 | | | |
| T16 | 57.8 | | | | 40.2 | | | |
| T17 | 50.4 | | | | 41.2 | | | |
| T18 | 53.6 | | | | 38.8 | | | |
| T19 | 0.0 | | | | 0.0 | | | |

All the present inventive compositions (T1 to T5) provide synergistic control as well as residual control of thrips up to 14 days, whereas all the known compositions (T6 to T11) do not provide residual control as seen in present compositions and the thrips control was found below 55.8% on 14 DAA of other compositions except present compositions.

TABLE 2b
Fruit borer larval control and chilli fruit yield

| | Fruit borer | Number of | Increase (%) |
|---|---|---|---|
| Treatment | larval | healthy fruits | in fruits |
| Number | control (%) | per plant | over UTC |
| T1 | 85.2 | 46.7 | 128.9 |
| T2 | 95.4 | 48.5 | 137.7 |
| T3 | 93.8 | 45.3 | 122.1 |
| T4 | 85.2 | 43.2 | 111.8 |
| T5 | 83.6 | 42.5 | 108.3 |
| T6 | 51.8 | 36.7 | 79.9 |
| T7 | 70.2 | 38.4 | 88.2 |
| T8 | 63.8 | 35.3 | 73.0 |
| T9 | 52.4 | 34.1 | 67.2 |
| T10 | 48.8 | 33.6 | 64.7 |
| T11 | 72.6 | 30.5 | 49.5 |
| T12 | 70.2 | 28.7 | 40.7 |
| T13 | 11.4 | 24.5 | 20.1 |
| T14 | 46.8 | 26.8 | 31.4 |
| T15 | 67.2 | 27.9 | 36.8 |
| T16 | 60.2 | 25.6 | 25.5 |
| T17 | 47.6 | 24.8 | 21.6 |
| T18 | 43.4 | 23.9 | 17.2 |
| T19 | 0.0 | 20.4 | 0.0 |

All the present inventive compositions (T1 to T5) provides excellent control of fruit borer larvae (>83%) and also produces higher number of marketable fruits per plant (>108 increase over UTC).

Conclusion: Among the various compositions as shown in Table 1 treatment number T1-T5 are considered to be present inventive compositions which showed excellent synergism and effectiveness against chilli thrips and fruit borer larva on chilli crop. The thrips control observed at 7 DAA (days after application) of T1-T5 were more than 96.8%. Particularly, T2 (99.2%) followed by T1 (98.4%) and T3 (98.2%) showed highest thrips control at 7 DAA, as well as on 14 DAA it was found to be more than 77.4%. Particularly, T1 (84.6%), T2 (81.2%) and (78.6%) showed highest thrips control at 14 DAA. Moreover, the colby's ratio is found to be >1 which means stronger synergism.

Furthermore, the fruit borer larval control of T1-T5 showed more than 83.6%. Particularly, T2 (95.4%) followed by (93.8%), T1 and T4 (85.2%) fruit borer larval control. In addition to that, the number of healthy fruits per plant was found to be more than 42.5. Particularly, T2 (48.5), T1 (46.7) and T3 (45.3) showed the highest number of healthy fruits per plant. Moreover, the increase in fruits over UTC (untreated check) was found to be more than 108.3%. Particularly, T2 (137.7%) followed by T1 (128.9%) and T3 (122.1%) increase in fruits over UTC (untreated check) which is an excellent result when compared with the known, farm tank mix, market products and in house developed formulations for field trial.

### Example 2: Red Spider Mite, Shoot and Fruit Borer Control and Yield in Brinjal

Crop: Brinjal
Location: Durg, Chhattishgarh
Number of treatments: 19
Plot size: 50 sq.m.
Crop age: 75 days after transplanting.
Method of application: Foliar spray with battery operated back pack sprayer.
Water volume: 510 liter per hectare

### Observation Methods:

Red spider mite (Tetranychus urticae) control (%): Count the number of motile stage of mite per unit area using 10× microscope. Record the observations from 5 spots per plant and 10 plants per plot. Calculate red spider mite control (%) and apply colby's formula.

$$Mite Control ( \% ) = 100 - \frac{number of live / motile stages of mite in treatment}{number of live / motile stages of mite in untreated ( UTC )} \times 100$$

Shoot and fruit borer (Leucinoides orbonalis) damage (%): The larvae of shoot and fruit borer causes damage to both the shoots and fruits in brinjal crop. Count the number of healthy and infested fruits per plant. Record the observations from randomly selected 10 plants per plot.

$$Fruit damage ( \% ) = \frac{number of infested fruits per 10 plants}{Total number of fruits observed per plants} \times 100$$

Fruit counts: Count the number of healthy marketable fruits from 5 plants per plot and calculate increase in healthy fruits over UTC.

TABLE 3
Treatment details

| Treat- | | gram active |
|---|---|---|
| ment | | ingredients |
| Number | Treatment compositions | per hectare |
| T1 | Fluxametamide 10% + Fenpyroximate 5% + | 30 + 15 + 6 |
| | Amino acid 2% SC | |
| T2 | Fluxametamide 6% + Hexythiazox 4% + | 30 + 20 + 6 |
| | Amino acid 1.2% SC | |
| T3 | Fluxametamide 6% + Etoxazole 5% + | 30 + 25 + 6 |
| | Amino acid 1.2% SC | |
| T4 | Fluxametamide 3% + Diafenthiuron 25% + | 30 + 250 + 6 |
| | Amino acid 0.6% SC | |
| T5 | Fluxametamide 6% + Azadirachtin 1% + | 30 + 5 + 6 |
| | Amino acid 1.2% EC | |
| T6 | Fluxametamide 10% + Fenpyroximate 5% SC | 30 + 15 |
| T7 | Fluxametamide 6% + Hexythiazox 4% SC | 30 + 20 |
| T8 | Fluxametamide 6% + Etoxazole 5% SC | 30 + 25 |
| T9 | Fluxametamide 3% + Diafenthiuron 25% SC | 30 + 250 |
| T10 | Fluxametamide 6% + Azadirachtin 1% EC | 30 + 5 |
| T11 | Fluxametamide 10% EC + Amino acid 80% | 30 + 6 |
| | WP (tank mix) | |
| T12 | Fluxametamide 10% EC | 30 |
| T13 | Amino acid 80% WP | 6 |
| T14 | Fenpyroximate 5% EC | 15 |
| T15 | Hexythiazox 5.45% EC | 20 |
| T16 | Etoxazole 10% SC | 25 |
| T17 | Diafenthiuron 47.8% SC | 250 |
| T18 | Azadirachtin 5% EC | 5 |
| T19 | Untreated Check (UTC) | — |

WP-wettable powder. T1 to T5 are innovative present compositions, T6 to T10 are known compositions, T11 on farm tank mix, T12 to T18 is market products.

TABLE 4a
Control of red spider mite control in brinjal

Red spider mite control (%)

| Treatment | control | control | Colby's | Synergism |
|---|---|---|---|---|
| Number | observed | expected | ratio | (Y/N) |
| T1 | 96.6 | 86.5 | 1.12 | Y |
| T2 | 97.2 | 86.8 | 1.12 | Y |
| T3 | 98.4 | 87.7 | 1.12 | Y |
| T4 | 94.8 | 84.9 | 1.12 | Y |
| T5 | 93.2 | 82.5 | 1.13 | Y |
| T6 | 72.6 | 68.8 | 1.06 | |
| T7 | 73.4 | 69.5 | 1.06 | |
| T8 | 75.6 | 71.6 | 1.06 | |
| T9 | 68.2 | 65.1 | 1.05 | |
| T10 | 62.4 | 59.6 | 1.05 | |
| T11 | 63.6 | 58.6 | 1.09 | |
| T12 | 56.8 | | | |
| T13 | 4.2 | | | |
| T14 | 67.4 | | | |
| T15 | 68.2 | | | |
| T16 | 70.4 | | | |
| T17 | 63.6 | | | |
| T18 | 57.8 | | | |
| T19 | 0.0 | | | |

All the innovative present compositions (T1 to T5) provide synergistic control and also shows higher efficacy against red spider mite infesting brinjal crop.

TABLE 4b
Efficacy against shoot and fruit borer
damage and yield in brinjal corp

| | Fruit | Number of | Increase (%) in |
|---|---|---|---|
| Treatment | damage | healthy fruits | healthy fruits |
| Number | (%) | per plant | over UTC |
| T1 | 1.58 | 31.5 | 87.5 |
| T2 | 1.73 | 30.8 | 83.3 |
| T3 | 1.83 | 30.2 | 79.8 |
| T4 | 1.36 | 31.9 | 89.9 |
| T5 | 1.17 | 32.7 | 94.6 |
| T6 | 2.94 | 25.8 | 53.6 |
| T7 | 3.26 | 24.3 | 44.6 |
| T8 | 3.42 | 23.8 | 41.7 |
| T9 | 2.76 | 26.3 | 56.5 |
| T10 | 2.24 | 27.5 | 63.7 |
| T11 | 4.13 | 23.1 | 37.5 |
| T12 | 5.17 | 22.5 | 33.9 |
| T13 | 9.25 | 19.7 | 17.3 |
| T14 | 6.84 | 21.5 | 28.0 |
| T15 | 7.32 | 20.8 | 23.8 |
| T16 | 8.18 | 20.3 | 20.8 |
| T17 | 6.13 | 21.7 | 29.2 |
| T18 | 5.82 | 22.1 | 31.5 |
| T19 | 13.68 | 16.8 | 0.0 |

All the innovative present compositions (T1 to T5) provide excellent 10 protection against shoot and fruit borer, and also produce higher number marketable fruits per plant.

Conclusion: Among the various compositions as shown in Table 3, T1-T5 are the present inventive compositons which showed excellent synergism and effectiveness against red spider mite, shoot and fruit borer in brinjal crop. The control of red spider mite was observed more than 93.2%. Particularly, T3 showed (98.4%) followed by T2 (97.2%) and T1 (96.6%) which showed excellent synergism when compared with known and market products. Moreover, the colby's ratio was found to be >1 depicting effective synergism when compared with the known, farm tank mix and market products.

Furthermore, T1-T5 has also proven more than 30.2 of number of healthy fruits per plant. Particularly, T5 showed 32.7 followed by T4 (31.9) and T1 (31.5) number of healthy fruits per plant which has proven better than the known, farm tank mix and market products. In addition to that, the fruit damage was observed less than 1.83% whereas the known, farm tank mix and market products have shown from 2.24 till 13.68% of fruit damage. Further, T1-T5 proved more than 79.8% of increament in healthy fruits over UTC (untreated check). Particularly, T5 showed (94.6%) followed by T4 (89.9%) and T1 (87.5%) increament in healthy fruits over UTC (untreated check) when compared with the known, farm tank mix and market products.

### Example 3: Pod Borer Larval Control and Yield in Red Gram

Crop: Redgram
Location: Dabhoi, Gujarat
Treatments: 19
Crop age: 112 days after sowing.
Spray water volume: 500 liter per hectare
Method of application: Foliar spray with battery operated knapsack sprayer fitted with hollow cone nozzle.

### Observation Methods:

Pod borer (Helicoverpa armigera) larval control (%): Count the number of live larvae per plant. Record observations from 10 plants per plot on 7th days after application.

$$\% Larval control = 100 - \frac{Number of live larva in treatment}{Number of live larva in untreated control} \times 100$$

Pod count: count the number of healthy pods of redgram per plant. Record the observations form 10 plants per plot. 10

T1: Composition of fluxametamide 4% + emamectin
benzoate 1.8% + fulvic acid 1.0% SC

| | Percent |
|---|---|
| Chemical composition | (w/w) |
| Fluxametamide a.i. | 4.00 |
| Emamectin Benzoate a.i. | 1.80 |
| Fulvic acid a.i. | 1.00 |
| Polyalkyleneoxide Modified Heptamethyltrisiloxane | 5.00 |
| (super wetting-spreading-penetrating agent) | |
| Tristyryl phenol ethoxylate phosphate esters | 4.50 |
| (dispersing agent I) | |
| Sodium salt of polycarboxylate (dispersing agent II) | 1.00 |
| Magnesium aluminum silicate (suspending agent) | 0.50 |
| Polydimethylsiloxane (anti foaming agent) | 0.30 |
| 1,2-benzisothiazolin-3(2H)-one (preservative) | 0.20 |
| Glycerin (anti freezing agent) | 5.00 |
| Xanthan gum (thickner) | 0.20 |
| Water (diluent) | 76.50 |
| Total | 100.00 |

a.i. (active ingredient) on 100% purity basis

T1: Storage stability-fluxametamide 4% +
emamectin benzoate 1.8% + fulvic acid 1.0% SC
Laboratory storage stability for 14 days

| | Specification | | At 54 ± | At 0 ± |
|---|---|---|---|---|
| Parameters | (in house) | Initial | 2° C. | 2° C. |
| Fluxametamide a.i. | 3.80 to 4.4 | 4.25 | 4.10 | 4.24 |
| Emamectin Benzoate a.i. | 1.71 to 1.98 | 1.90 | 1.8 | 1.9 |
| Fulvic acid a.i. | 0.95 to 1.1 | 1.10 | 1.05 | 1.1 |
| Fluxametamide | 80 | 98.50 | 98.50 | 98.30 |
| suspensibility (%) | | | | |
| Emamectin Benzoate | 80 | 98.60 | 98.60 | 98.40 |
| suspensibility (%) | | | | |
| Fulvic acid | 80 | 98.00 | 98.00 | 97.60 |
| suspensibility (%) | | | | |
| pH range (1% aq. | 4.5 to 7.0 | 5.50 | 5.50 | 5.50 |
| Suspension) | | | | |
| Pourability (%) | 95 | 98.20 | 98.20 | 97.80 |
| Specific gravity | 1.05-1.10 | 1.07 | 1.07 | 1.07 |
| Viscosity at spindle | 350-800 | 550 | 550 | 550 |
| no. 62, 20 rpm | cps | | | |
| Particle size (micron) | D50 < 3, | 2.1, 8.6 | 2.1, 8.6 | 2.1, 8.7 |
| | D90 < 10 | | | |
| Persistent foam ml (after 1 | 60 | nil | nil | nil |
| minute) max. | | | | |

T1: Room temperature storage stability up to 12 months

| | Specification | | 1 | 6 | 12 |
|---|---|---|---|---|---|
| Parameters | (in house) | Initial | month | months | months |
| Fluxametamide a.i. | 3.80 to 4.4 | 4.25 | 4.25 | 4.24 | 4.20 |
| Emamectin Benzoate a.i. | 1.71 to 1.98 | 1.90 | 1.90 | 1.9 | 1.85 |
| Fulvic acid a.i. | 0.95 to 1.1 | 1.10 | 1.10 | 1.1 | 1.09 |
| Fluxametamide | 80 | 98.50 | 98.50 | 98.30 | 98.50 |
| suspensibility (%) | | | | | |
| Emamectin Benzoate | 80 | 98.60 | 98.60 | 98.40 | 98.60 |
| suspensibility (%) | | | | | |
| Fulvic acid | 80 | 98.00 | 98.00 | 97.60 | 98.00 |
| suspensibility (%) | | | | | |
| pH range (1% aq. | 4.5 to 7.0 | 5.50 | 5.50 | 5.50 | 5.65 |
| Suspension) | | | | | |
| Pourability (%) | 95 | 98.20 | 98.20 | 97.80 | 98.20 |
| Specific gravity | 1.05-1.10 | 1.07 | 1.07 | 1.07 | 1.07 |
| Viscosity at spindle | 350-800 cps | 550 | 550 | 550 | 550 |
| no. 62, 20 rpm | | | | | |
| Particle size (micron) | D50 < 3, | 2.1, 8.6 | 2.1, 8.6 | 2.1, 8.7 | 2.1, 8.6 |
| | D90 < 10 | | | | |
| Persistent foam in ml | 60 | nil | nil | nil | nil |
| (after 1 minute) max. | | | | | |

The composition of fluxametamide 4% + emamectin benzoate 1.8% + fulvic acid 1.0% SC meets all the criteria for storage stability studies in laboratory (at 54 ± 2° C. and at 0 ± 2° C. for 14 days) and room temperature (for 12 months).

### T1: Manufacturing Process for 100 kg Batch of Fluxametamide 4%+Emamectin Benzoate 1.8%+Fulvic Acid 1.0% SC

Step 1—Gum solution: Xanthan gum (2.0 kg) and 1,2-benzisothiazoline-3-one (2.0 kg) were charged into 96.0 kg water and homogenized. The above mentioned mixture was prepared 12-18 hours prior its use.
Step 2—DM water (66.5 kg) and 1,2-propylene glycol (5 kg) were charged into designated vessel and mixed thoroughly.
Step 3—The sodium salt of polycarboxylate (1.5 kg), tristyryl phenol ethoxylate phosphate esters (4.5 kg) and aluminum magnesium silicate (0.5 kg) were added into the vessel having water and the contents are homogenised for 45-60 minutes by using the high shear homogeniser.
Step 4—Fluxametamide (4 kg), emamectin benzoate (1.8 kg) and fulvic acid (1.0 kg) were added slowly to this premix and homogenised to achieve uniform slurry ready for grinding.
Step 5—Half of the quantity of polydimethylsiloxane (0.15 kg) was added before grinding and then the material was subjected for grinding in dyno mill till the desired particle size was achieved.
Step 6—After the completion of the grinding process and before the sampling for in process analysis, the remaining polydimethyl siloxane (0.15 kg) antifoam was added.
Step 7—10.0 kg of 2% xanthum gum solution and 5.0 kg of polyalkyleneoxide modified heptamethyltrisiloxane were added to this formulation and homogenized for 30 minutes.
Step 8—The final formulation was sent to QC for quality check.

TABLE 5
Treatment details

| Treat- | | gram actives |
|---|---|---|
| ment | | ingredients |
| Number | Treatment compositions | per hectare |
| T1 | Fluxametamide 4% + Emamectin benzoate | 20 + 9 + 5 |
| | 1.8% + Fulvic acid 1% SC | |
| T2 | Fluxametamide 4% + Methoxyfenozide | 20 + 90 + 5 |
| | 18% + Fulvic acid 1% SC | |
| T3 | Fluxametamide 4% + Spinosad 10% + Fulvic | 20 + 50 + 5 |
| | acid 1% SC | |
| T4 | Fluxametamide 4% + Spinetoram 8% + Fulvic | 20 + 40 + 5 |
| | acid 1% SC | |
| T5 | Fluxametamide 4% + Indoxacarb 10% + Fulvic | 20 + 50 + 5 |
| | acid 1% SC | |
| T6 | Fluxametamide 4% + Emamectin benzoate | 20 + 9 |
| | 1.8% SC | |
| T7 | Fluxametamide 4% + Methoxyfenozide 18% SC | 20 + 90 |
| T8 | Fluxametamide 4% + Spinosad 10% SC | 20 + 50 |
| T9 | Fluxametamide 4% + Spinetoram 8% SC | 20 + 40 |
| T10 | Fluxametamide 4% + Indoxacarb 10% SC | 20 + 50 |
| T11 | Fluxametamide 10% EC + Fulvic acid 80% | 20 + 5 |
| | WP (tank mix) | |
| T12 | Fluxametamide 10% EC | 20 |
| T13 | Fulvic acid 80% WP | 5 |
| T14 | Emamectin benzoate 1.9% EC | 9 |
| T15 | Methoxyfenozide 24% SC | 90 |
| T16 | Spinosad 45% SC | 50 |
| T17 | Spinetoram 21.7% SC | 40 |
| T18 | Indoxacarb 15% SC | 50 |
| T19 | Untreated Check (UTC) | — |

T1 to 15 are present innovative compositions, T6 to T10 are known compositions, and T11 on farm tank mix, T12 to T18 is market products.

TABLE 6
Pod borer larval control and pod yield in red gram

| | | | | | | Number of | Increase (%) |
|---|---|---|---|---|---|---|---|
| | Pod borer larval control (%) | | | | Pod | healthy | in healthy |
| Treatment | control | control | Colby's | Synergism | damage | pods per | pods over |
| Number | observed | expected | ratio | (Y/N) | (%) | plant | UTC |
| T1 | 98.2 | 86.1 | 1.14 | Y | 0.51 | 126.7 | 113.7 |
| T2 | 98.7 | 87.3 | 1.13 | Y | 0.42 | 122.5 | 106.6 |
| T3 | 99.2 | 89.0 | 1.12 | Y | 0.27 | 130.2 | 119.6 |
| T4 | 99.4 | 89.4 | 1.11 | Y | 0.19 | 133.5 | 125.1 |
| T5 | 100.0 | 91.0 | 1.10 | Y | 0.16 | 137.7 | 132.2 |
| T6 | 82.4 | 64.8 | 1.27 | | 1.06 | 90.5 | 52.6 |
| T7 | 83.8 | 68.0 | 1.23 | | 0.95 | 87.4 | 47.4 |
| T8 | 86.4 | 72.1 | 1.20 | | 0.87 | 91.2 | 53.8 |
| T9 | 87.2 | 73.2 | 1.19 | | 0.73 | 96.3 | 62.4 |
| T10 | 88.7 | 77.3 | 1.15 | | 0.57 | 98.7 | 66.4 |
| T11 | 67.8 | 62.9 | 1.08 | | 1.97 | 83.5 | 40.8 |
| T12 | 60.4 | | | | 3.15 | 70.3 | 18.5 |
| T13 | 6.4 | | | | 5.73 | 66.4 | 12.0 |
| T14 | 62.4 | | | | 2.86 | 72.4 | 22.1 |
| T15 | 65.8 | | | | 2.13 | 70.9 | 19.6 |
| T16 | 70.2 | | | | 1.83 | 73.4 | 23.8 |
| T17 | 71.4 | | | | 1.65 | 77.6 | 30.9 |
| T18 | 75.8 | | | | 1.26 | 80.3 | 35.4 |
| T19 | 0.0 | | | | 8.77 | 59.3 | 0.0 |

All the present innovative compositions (T1 to T5) provides synergistic control of pod borer larvae and provides excellent protections to pod (<0.51% pod damage), and also yielded higher number of healthy pods per plant (>106%) as compared to all known compositions, on farm tank mixes and market products.

Conclusion: Among the various compositions as shown in Table 5 treatment number T1-T5 are considered to be present inventive compositions which showed excellent synergism and effectiveness against pod borer larva control in red gram. Moreover, the control of pod borer larva showed more than 98.2%. In particular, T5 showed (100%) followed by T4 (99.4%) and T3 (99.2%) which has proved an excellent control as compared to fram tank mix and market products.

In addition to that, T1-T5 have shown less number of pod damage <0.51% as compared to known, farm tank mix and market products which depicted from 0.57% to 8.77% of pod damage. Furthermore, T1-T5 showed more than 122.5 numbers of healthy pods per plant. Particularly, T5 showed (137.7) followed by T4 (133.5) and T3 (130.2) number of healthy pods per plant when compared with the known, farm tank mix and market products. At last but not the least, T1-T5 showed more than 106.6% increase in healthy pods over UTC (untreated check). Particularly, T5 showed (132.2%) followed by T4 (125.1%) and T3 (119.6%) showed increase in healthy pods over UTC (untreated check) as compared to the known, farm tank mix and market products.

### Example 4: Whitefly Control in Bottle Gourd

Crop: Bottlegourd
Location: Kheda, Gujarat
Treatments: 11
Crop age: 60 days after sowing.
Spray water volume: 440 liter per hectare
Method of application: Foliar spray with battery operated knapsack sprayer fitted with hollow cone nozzle.

### Observation Methods:

Whitefly (Bemesia tabaci) control (%): Count the number of live whitefly (nymphs and adults) per leaf, record the observations from 5 leaves per vine and 5 vines per plot.

$$\% Whitefly control = 100 - \frac{Number of live whitefly in treated plot}{Number of live whitefly in untreated ( UTC ) plot} \times 100$$

T3: Composition of fluxametamide 7% + flonicamid
8% + ortho silicic acid 2% WG

| | Percent |
|---|---|
| Chemical composition | (w/w) |
| Fluxametamide a.i. | 7.00 |
| Flonicamid a.i. | 8.00 |
| Ortho silicic acid a.i. | 2.00 |
| Modified Sodium lignosulphonate | 7.00 |
| (dispersing agent I) | |
| Modified polyacrylate copolymer | 3.00 |
| (dispersing agent II) | |
| Sodium isopropyl naphthalene | 5.00 |
| sulfonate (wetting agent) | |
| Polydimethylsiloxane | 1.00 |
| (Antifoaming Agent) | |
| Corn Starch | 15.00 |
| China clay | 52.00 |
| Total | 100.00 |

a.i. (active ingredient/) on 100% purity basis

T3: Storage Stability: fluxametamide 7% +
flonicamid 8% + ortho silicic acid 2% WG
Laboratory storage stability for 14 days

| | Specification | | At 54 ± | At 0 ± |
|---|---|---|---|---|
| Parameters | (in house) | Initial | 2° C. | 2° C. |
| Fluxametamide a.i. | 6.65 to 7.70 | 7.30 | 7.14 | 7.3 |
| Flonicamid a.i. | 7.60 to 8.80 | 8.25 | 8.15 | 8.24 |
| Ortho silicic acid a.i. | 1.90 to 2.20 | 2.15 | 2.08 | 2.15 |
| Fluxametamide | 70 | 98.40 | 97.30 | 98.20 |
| suspensibility (%) | | | | |
| Flonicamid suspensibility | 70 | 98.20 | 97.50 | 98.20 |
| (%) | | | | |
| Ortho silicic acid | 70 | 98.80 | 97.40 | 98.60 |
| suspensibility (%) | | | | |
| pH range (1% aq. | 5 to 9 | 7.50 | 7.60 | 7.50 |
| Suspension) | | | | |
| Wettability | Max 30 s | 10 | 12 | 10 |
| Wet Sieve(45 micron) | Mini 98.5% | 99.5 | 99.4 | 99.5 |
| Bulk Density | 0.45-0.85 | 0.5 | 0.5 | 0.5 |
| Moisture Content | Max 2.0% | 1.4 | 1.2 | 1.4 |
| Persistent foam ml | 60 | nil | nil | nil |
| (after 1 minute) max. | | | | |

T3: Room temperature storage stability up to 12 months

| | Specification | | 1 | 6 | 12 |
|---|---|---|---|---|---|
| Parameters | (in house) | Initial | month | month | month |
| Fluxametamide a.i. | 6.65 to 7.70 | 7.30 | 7.30 | 7.3 | 7.24 |
| Flonicamid a.i. | 7.60 to 8.80 | 8.25 | 8.25 | 8.25 | 8.21 |
| Ortho silicic acid a.i. | 1.90 to 2.20 | 2.15 | 2.15 | 2.15 | 2.08 |
| Fluxametamide | 70 | 98.40 | 98.40 | 98.40 | 98.30 |
| suspensibility (%) | | | | | |
| Flonicamid | 70 | 98.20 | 98.20 | 98.10 | 98.10 |
| suspensibility (%) | | | | | |
| Ortho silicic acid | 70 | 98.80 | 98.80 | 98.80 | 98.70 |
| suspensibility (%) | | | | | |
| pH range (1% aq. | 5 to 9 | 7.50 | 7.50 | 7.50 | 7.55 |
| Suspension) | | | | | |
| Wettability | Max 30 s | 10 | 10 | 10 | 11 |
| Wet Sieve(45 micron) | Mini 98.5% | 99.5 | 99.5 | 99.5 | 99.5 |
| Bulk Density | 0.45-0.85 | 0.5 | 0.5 | 0.5 | 0.5 |
| Moisture Content | Max 2.0% | 1.4 | 1.4 | 1.4 | 1.3 |
| Persistent foam ml (after | 60 | nil | nil | nil | nil |
| 1 minute) max. | | | | | |

The composition of fluxametamide 7%+flonicamid 8%+ortho silicic acid 2% WG meets the all inhouse specifications for storage stability studies in laboratory (at 54±2° C. and at 0±2° C. for 14 days) and room temperature (for 12 months).

### T3: Manufacturing Process for 100 kg Batch of Fluxametamide 7%+Flonicamid 8%+Ortho Silicic Acid 2% WG

Step 1—The 52.0 kg china clay, 15.0 kg corn starch, 0.5 kg silicone antifoam, 5 kg of sodium isopropyl naphthalene sulfonate, 3 kg modified polyacrylate copolymer and 7.0 kg of modified sodium lignosulphonate were charged and blended into a ribbon or premix blender and homogenized for 30 minutes.
Step 2—7.0 kg fluxametamide, 8 kg flonicamid and 2.0 kg ortho silicic acid were charged and homogenized again for 30 minutes. The pre-blended material was grinded through jet mill/air classifier mills. Further, the finely grinded material was blended in post blender till the homogenousity was achieved (for approx 1.5 hr)
Step 3—The finely grinded powder was mixed with 10 kg of water having 0.5 kg silicone antifoam to form extrudable dough.
Step 4—Dough was passed through an extruder to get granules of required size.
Step 5—Wet granules were passed through fluidized bed drier to remove 10 kg extra water added and further graded using vibrating screens.
Step 6—The final product was sent for QC approval.
Step 7—The material was packed in its required package sizes when received approval.

TABLE 7
Treatment details

| | | gram actives |
|---|---|---|
| Treatment | | ingredients |
| Number | Treatment compositions | per hectare |
| T1 | Fluxametamide 7% + Pyrifluquinazon | 35 + 60 + 10 |
| | 12% + Ortho silicic acid 2% SC | |
| T2 | Fluxametamide 7% + Afidopyropen 7% + | 35 + 35 + 10 |
| | Ortho silicic acid 2% OD | |
| T3 | Fluxametamide 7% + Flonicamid 8% + | 35 + 40 + 10 |
| | Ortho silicic acid 2% WG | |
| T4 | Fluxametamide 3.5% + Pyriproxyfen 7% + | 35 + 70 + 10 |
| | Ortho silicic acid 1% EC | |
| T5 | Fluxametamide 10% EC | 35 |
| T6 | Ortho silicic acid 2% L | 10 |
| T7 | Pyrifluquinazon 20% WG | 60 |
| T8 | Afidopyropen 5% DC | 35 |
| T9 | Flonicamid 50% WG | 40 |
| T10 | Pyriproxyfen 10% EC | 70 |
| T11 | Untreated Check (UTC) | — |

OD—oil dispersion, WG—water dispersible/wettable granule, T1 to T4 are present innovative compositions, T5 to T10 are market products.

TABLE 8
Whitefly control in bottlegourd

Whitefly control (%) at 7 DAA

| Treatment | control | control | Colby's | Synergism |
|---|---|---|---|---|
| Number | observed | expected | ratio | (Y/N) |
| T1 | 98.2 | 86.3 | 1.14 | Y |
| T2 | 96.4 | 82.7 | 1.17 | Y |
| T3 | 95.4 | 80.6 | 1.18 | Y |
| T4 | 98.8 | 87.1 | 1.13 | Y |
| T5 | 56.8 | | | |
| T6 | 8.6 | | | |
| T7 | 65.4 | | | |
| T8 | 56.2 | | | |
| T9 | 50.8 | | | |
| T10 | 67.4 | | | |
| T11 | 0.0 | | | |

All the present innovative compositions (T1 to T4) provide synergistic control of whitefly infesting bottle gourd crop.

Conclusion: Among the various compositions as shown in Table 7 treatment numbers T1-T4 are considered to be present inventive compositions which showed more than 95.4% white fly control at 7 DAA (days after application) and gave an excellent synergism and effectiveness against whitefly control in bottle gourd. In particular, T4 showed (98.8%) followed by T1 (98.2%) and T2 (96.4%) whitefly control at 7 DAA as compared to the market products. In addition to that, the colby's ratio for T1-T4 has shown >1 which proves an excellent synergism as compared to other market products.

### Example 5: Jassid and Fruit Borer Larval Control in Okra

Crop: Okra
Location: Raipur, Chhattishgarh
Treatments: 19
Crop age: 77 days after sowing
Spray water volume: 490 liter per hectare
Method of application: Foliar spray with battery operated knapsack sprayer fitted with hollow cone nozzle.

### Observation Methods:

Jassid (Amrasca biguttula biguttula) control (%): Count the number of live jassid per leaf, record the observations from 3 leaves per plant and 10 plants per plot. Calculate Jassid control (%). Record the observations at 3 and 10 DAA.

Fruit borer (mixed infestation of Helicoverpa armigera and Spodoptera exigua) larval control (%): same as given in example 1.

TABLE 9
Treatment details

| Treat- | | gram actives |
|---|---|---|
| ment | | ingredients |
| Number | Treatment compositions | per hectare |
| T1 | Fluxametamide 5% + Lambda cyhalothrin | 25 + 25 + 1 |
| | 5% + GA 0.2% EC | |
| T2 | Fluxametamide 5% + Bifenthrin 8% + | 25 + 40 + 1 |
| | GA 0.2% SC | |
| T3 | Fluxametamide 5% + Fenpropathrin | 25 + 50 + 1 |
| | 10% + GA 0.2% EC | |
| T4 | Fluxametamide 5% + Deltamethrin 2% + | 25 + 10 + 1 |
| | GA 0.2% EC | |
| T5 | Fluxametamide 5% + Cypermethrin 6% + | 25 + 30 + 1 |
| | GA 0.2% EC | |
| T6 | Fluxametamide 5% + Lambda cyhalothrin 5% EC | 25 + 25 |
| T7 | Fluxametamide 5% + Bifenthrin 8% EC | 25 + 40 |
| T8 | Fluxametamide 5% + Fenpropathrin 10% EC | 25 + 50 |
| T9 | Fluxametamide 5% + Deltamethrin 2% EC | 25 + 10 |
| T10 | Fluxametamide 5% + Cypermethrin 6% EC | 25 + 30 |
| T11 | Fluxametamide 10% EC + Gibberellic acid | 25 + 1 |
| | 40% WSG (tank mix) | |
| T12 | Fluxametamide 10% EC | 25 |
| T13 | Gibberellic acid (GA) 40% WSG | 1 |
| T14 | Lambda cyhalothrin 5% EC | 25 |
| T15 | Bifenthrin 10% EC | 40 |
| T16 | Fenpropathrin 10% EC | 50 |
| T17 | Deltamethrin 11% EC | 10 |
| T18 | Cypermethrin 10% EC | 30 |
| T19 | Untreated Check (UTC) | — |

GA—gibberellic acid. T1 to T5 are present innovative compositions, T6 to T10 are known compositions, and T11 on farm tank mix, T12 to T18 is market products.

TABLE 10
Jassid control in okra crop

| | Jassid control (%) | | | | | | | |
|---|---|---|---|---|---|---|---|---|
| | at 3 DAA | | | | at 10 DAA | | | |
| Treatment | control | control | Colby's | Synergism | control | control | Colby's | Synergism |
| Number | observed | expected | ratio | (Y/N) | observed | expected | ratio | (Y/N) |
| T1 | 98.4 | 87.3 | 1.13 | Y | 83.4 | 76.6 | 1.09 | Y |
| T2 | 99.6 | 88.1 | 1.13 | Y | 85.6 | 77.5 | 1.10 | Y |
| T3 | 98.2 | 87.1 | 1.13 | Y | 82.6 | 76.0 | 1.09 | Y |
| T4 | 97.4 | 86.6 | 1.12 | Y | 81.2 | 75.5 | 1.07 | Y |
| T5 | 96.8 | 86.1 | 1.12 | Y | 80.4 | 75.1 | 1.07 | Y |
| T6 | 65.4 | 60.0 | 1.09 | | 42.6 | 44.9 | 0.95 | |
| T7 | 68.4 | 62.7 | 1.09 | | 45.6 | 47.0 | 0.97 | |
| T8 | 64.2 | 59.4 | 1.08 | | 41.6 | 43.5 | 0.96 | |
| T9 | 63.0 | 57.9 | 1.09 | | 40.8 | 42.3 | 0.96 | |
| T10 | 62.6 | 56.4 | 1.11 | | 40.2 | 41.3 | 0.97 | |
| T11 | 74.4 | 69.7 | 1.07 | | 56.4 | 58.1 | 0.97 | |
| T12 | 68.2 | | | | 57.6 | | | |
| T13 | 4.8 | | | | 1.2 | | | |
| T14 | 58.0 | | | | 44.2 | | | |
| T15 | 60.8 | | | | 46.4 | | | |
| T16 | 57.4 | | | | 42.8 | | | |
| T17 | 55.8 | | | | 41.6 | | | |
| T18 | 54.2 | | | | 40.6 | | | |
| T19 | 0.0 | | | | 0.0 | | | |

All the present inventive compositions (T1 to T5) provides synergistic control, as well as residual control of jassid up to 10 days, whereas all the known compositions (T6 to T11) does not provide residual control and the jassid control was found to be <57.6% on 10 DAA.

TABLE 11
Fruit borer larval control and fruit yield in okra crop

| | Fruit borer | Number of | Increase (%) |
|---|---|---|---|
| Treatment | larval | healthy fruits | in fruits |
| Number | control (%) | 10 per plant | over UTC |
| T1 | 84.6 | 43.5 | 51.6 |
| T2 | 83.2 | 45.2 | 57.5 |
| T3 | 85.8 | 47.3 | 64.8 |
| T4 | 83.4 | 44.8 | 56.1 |
| T5 | 86.2 | 46.1 | 60.6 |
| T6 | 80.2 | 37.5 | 30.7 |
| T7 | 78.8 | 36.9 | 28.6 |
| T8 | 80.4 | 39.7 | 38.3 |
| T9 | 78.4 | 38.3 | 33.4 |
| T10 | 79.2 | 38.9 | 35.5 |
| T11 | 68.2 | 34.3 | 19.5 |
| T12 | 63.6 | 33.8 | 17.8 |
| T13 | 1.2 | 30.3 | 5.6 |
| T14 | 46.8 | 31.3 | 9.1 |
| T15 | 45.2 | 31.6 | 10.1 |
| T16 | 44.8 | 32.4 | 12.9 |
| T17 | 43.6 | 32.8 | 14.3 |
| T18 | 44.6 | 32.9 | 14.6 |
| T19 | 0.0 | 28.7 | 0.0 |

All the present compositions (T1 to T5) provide excellent control of fruit borer larvae and also yielded higher number of healthy fruits.

Conclusion: Among the various compositions as shown in Table 9 treatment number T1-T5 are considered to be present inventive compositions which showed excellent synergism and effectiveness against jassid and fruit borer larva in okra. Further, T1-T5 showed more than 96.8% of jassid control at 3 DAA (days after application). Particularly, T2 showed (99.6%) followed by T1 (98.4%) and T3 (98.2%) proving effective synergism at 3 DAA. Moreover, the treatment number T1-T5 showed more than 80.4% of control on jasid at 10 DAA. In particular, T2 showed 85.6% followed by T1 (83.4%) and T3 (82.6%) control on jassid at 10 DAA and also depicted >1 colby's ratio which means effective and stronger synergism.

Furthermore, T1-T5 showed more than 83.2% of fruit borer larval control. Particularly, T5 showed (86.2%) followed by T3 (85.85) and T1 (84.6%). In addition to that, T1-T5 showed >43.5 number of healthy fruits 10 per plant. In particular, the number of healthy fruits 10 per plant was found to be T3 (47.3) followed by T5 (46.1) and T2 (45.2) as compared to farm tank mix and market products. At last but not the least, the increase in fruits over UTC (untreated check) was found to be >51.6. Particularly, T3 showed (64.8%) followed by T5 (60.6%) and T2 (57.5%) showed increase in fruits over UTC (untreated check) when compared with the other known, farm tank mix and market products.

### Example 6: Sucking Pests Control in Cotton Crop

Crop: Cotton
Location: Gondal, Gujarat
Treatments: 11
Crop age: 70 days after sowing.
Spray water volume: 450 liter per hectare
Method of application: Foliar spray with battery operated knapsack sprayer fitted with hollow cone nozzle.

### Observation Methods:

Sucking pests include Thrips (Thrips tabaci) and Jassid (Amrasca biguttula biguttula). Observations method is same as per experiment no. 5.

$$\% sucking insect control = 100 - \frac{number of live insects in treatment}{number of live insects in untreated} \times 100$$

T1: Composition of fluxametamide 5% + spirotetramat
10% + paclobutrazol 5% OD

| | Percent |
|---|---|
| Chemical composition | (w/w) |
| Fluxametamide a.i. | 5.00 |
| Spirotetramat a.i. | 10.00 |
| Paclobutrazol a.i. | 5.00 |
| Polyoxyethylene sorbitol hexaoleate (Oil | 10.00 |
| Emulsifier) | |
| Salts of polyolefin condensates (Non-Aqueous | 2.50 |
| dispersant) | |
| Ethoxylated sorbitan ester (Co-Emulsifier) | 8.50 |
| Bentonite clay (Rheology modifier) | 1.50 |
| Styrene acrylic polymer (Aqueous dispersant) | 1.50 |
| Methylated seed oil (Oil continuous phase) | 56.00 |
| Total | 100.00 |

a.i. (active ingredient/) on 100% purity basis

T1: Storage Stability: fluxametamide 5% +
spirotetramat 10% + paclobutrazol 5% OD
Laboratory storage stability for 14 days

| | Specification | | At 54 ± | At 0 ± |
|---|---|---|---|---|
| Parameters | (in house) | Initial | 2° C. | 2° C. |
| Fluxametamide a.i. | 4.75 to 5.50 | 5.30 | 5.20 | 5.30 |
| Spirotetramat a.i. | 9.5 to 10.5 | 10.35 | 10.25 | 10.33 |
| Paclobutrazol a.i. | 4.75 to 5.50 | 5.25 | 5.15 | 5.25 |
| Fluxametamide suspensibility (%) | 80 | 98.90 | 98.10 | 98.80 |
| Spirotetramat suspensibility (%) | 80 | 99.00 | 98.50 | 98.90 |
| Paclobutrazol suspensibility (%) | 80 | 98.80 | 98.10 | 98.80 |
| pH range (1% aq. Suspension) | 5.5 to 8.0 | 6.90 | 7.05 | 6.90 |
| Pourability (%) | 95 | 98.20 | 98.10 | 98.20 |
| Specific gravity | 1.00-1.10 | 1.03 | 1.03 | 1.03 |
| Viscosity at spindle no. 62, 20 rpm | 350-800 cps | 510 | 520 | 510 |
| Particle size (micron) | D50 < 3, | 2.1, 8.0 | 2.1, 8.2 | 2.1, 8.1 |
| | D90 < 10 | | | |
| Persistent foam ml (after 1 | 60 | nil | nil | nil |
| minute) max. | | | | |

T1: Room temperature storage stability up to 12 months

| | Specification | | 1 | 6 | 12 |
|---|---|---|---|---|---|
| Parameters | (in house) | Initial | month | month | month |
| Fluxametamide a.i. | 4.75 to 5.50 | 5.30 | 5.30 | 5.30 | 5.25 |
| Spirotetramat a.i. | 9.5 to 10.5 | 10.35 | 10.33 | 10.33 | 10.3 |
| Paclobutrazol a.i. | 4.75 to 5.50 | 5.25 | 5.25 | 5.25 | 5.23 |
| Fluxametamide | 80 | 98.90 | 98.90 | 98.80 | 98.80 |
| suspensibility (%) | | | | | |
| Spirotetramat suspensibility | 80 | 99.00 | 98.90 | 98.90 | 98.80 |
| (%) | | | | | |
| Paclobutrazol suspensibility | 80 | 98.80 | 98.80 | 98.70 | 98.70 |
| (%) | | | | | |
| pH range (1% aq. | 5.5 to 8.0 | 6.90 | 6.90 | 6.90 | 6.95 |
| Suspension) | | | | | |
| Pourability (%) | 95 | 98.20 | 98.20 | 98.20 | 98.20 |
| Specific gravity | 1.00-1.10 | 1.03 | 1.03 | 1.03 | 1.03 |
| Viscosity at spindle no. 62, | 350-800 cps | 510 | 510 | 510 | 515 |
| 20 rpm | | | | | |
| Particle size (micron) | D50 < 3, | 2.1, 8.0 | 2.1, 8.1 | 2.1, 8.1 | 2.1, 8.1 |
| | D90 < 10 | | | | |
| Persistent foam in ml (after 1 | 60 | nil | nil | nil | nil |
| minute) max. | | | | | |

The composition of fluxametamide 5%+spirotetramat 10%+paclobutrazol 5% OD meets the all inhouse specifications for storage stability studies in laboratory (at 54±2° C. and at 0±2° C. for 14 days) and room temperature (for 12 months).

### T1: Manufacturing Process for 100 kg Batch of Fluxametamide 5%+Spirotetramat 10%+Paclobutrazol 5% OD

Step 1: Bentonite clay solution preparation: 15 kg of precipitated silica was added in to 85 kg of methylated seed oil and kept for 12-18 hours prior use and homogenized till it got completely dissolved.
Step 2: OD premix: 46.0 kg of methylated seed oil was charged into a designated vessel for OD production.
Step 3:10.0 kg of polyoxyethylene sorbitol hexaoleate, 1.50 kg of styrene acrylic polymer, 8.50 kg of ethoxylated sorbitan ester, 2.50 kg of salts of polyolefin condensates and 0.15 kg of polydimethyl siloxane were added and homogenised the contents for 45-60 minutes using high shear homogeniser.
Step 4:5.0 kg of fluxametamide, 10.0 kg of spirotetramat and 5.0 kg of paclobutrazol were added into this premix and homogenized for 30-45 minutes.
Step 5: The remaining 0.15 kg of silicon antifoam and 10 kg of 15% silica solution were added after milling to avoid foaming.
Step 6: The final formulation was sent to QC for quality check.

TABLE 12
Treatment details

| | | gram actives |
|---|---|---|
| Treatment | | ingredients |
| Number | Treatment compositions | per hectare |
| T1 | Fluxametamide 5% + Spirotetramat | 25 + 50 + 25 |
| | 10% + Paclobutrazol 5% OD | |
| T2 | Fluxametamide 5% + Spirodiclofen | 25 + 60 + 25 |
| | 12% + Paclobutrazol 5% OD | |
| T3 | Fluxametamide 2.5% + Spiromesifen | 25 + 100 + 25 |
| | 10% + Paclobutrazol 2.5% SC | |
| T4 | Fluxametamide 5% + Spiropidion | 25 + 40 + 25 |
| | 8% + Paclobutrazol 5% SC | |
| T5 | Fluxametamide 10% EC | 25 |
| T6 | Paclobutrazol 23% SC | 25 |
| T7 | Spirotetramat 15.31% OD | 50 |
| T8 | Spirodiclofen 24% SC | 60 |
| T9 | Spiromesifen 22.9% SC | 100 |
| T10 | Spiropidion 20% SC | 40 |
| T11 | Untreated Check (UTC) | — |

### T1 to T4 are Present Innovative Compositions, T5 to T10 are Market Products.

TABLE 13
Sucking pests control and fruiting bodies count in cotton

| | Sucking pests control (%) at 7 DAA | | | | Number of | Increase (%) |
|---|---|---|---|---|---|---|
| Treat- | control | control | | Syner- | fruiting | in fruiting |
| ment | ob- | ex- | Colby's | gism | bodies per | bodies |
| Number | served | pected | ratio | (Y/N) | plant | over T11 |
| T1 | 96.4 | 80.4 | 1.20 | Y | 64.7 | 51.9 |
| T2 | 94.6 | 79.5 | 1.19 | Y | 60.3 | 41.5 |
| T3 | 97.2 | 80.6 | 1.21 | Y | 62.9 | 47.7 |
| T4 | 98.8 | 83.2 | 1.19 | Y | 66.3 | 55.6 |
| T5 | 57.4 | | | | 55.4 | 30.0 |
| T6 | 10.2 | | | | 50.2 | 17.8 |
| T7 | 48.8 | | | | 51.3 | 20.4 |
| T8 | 46.4 | | | | 49.8 | 16.9 |
| T9 | 49.2 | | | | 50.3 | 18.1 |
| T10 | 56.2 | | | | 48.7 | 14.3 |
| T11 | 0.0 | | | | 42.6 | 0.0 |

All the present compositions (T1 to T4) provide synergistic control of sucking pests of cotton and yielded higher number of fruiting bodies per plant.

Conclusion: Among the various compositions as shown in Table 12 treatment number T1-T4 are considered to be present inventive compositions which showed excellent synergism and effectiveness against sucking pests control in cotton crop. Further, T1-T4 showed more than 94.6% control on sucking pests at 7 DAA (days after application). In particular, T4 showed (98.8%) followed by T3 (97.2%) and T1 (96.4%) at 7 DAA when compared to other market products. Moreover, the treatment number T1-T4 showed more than 60.3 numbers of fruiting bodies per plant. Particularly, T4 showed (66.3) followed by T1 (64.7) and T3 (62.9) as compared to market products. In addition to that, T1-T4 depicted more than 41.5% increase in fruiting bodies over T11 [UTC]. Particularly, T4 showed (55.6%) followed by T1 (51.9%) and T3 (47.7%) increament in fruiting bodies over T11 [UTC] when compared to market products.

### Example 7: Control of BPH (Brown Plant Hopper) in Rice

Crop: Rice
Location: Rajim, Chhattishgarh
Treatments: 11
Spray water volume: 450 liter per hectare
Method of application: Foliar spray with battery operated knapsack sprayer fitted with hollow cone nozzle.

### Observation Methods:

BPH (Nilaparvata lugens) control: count the number of live BPH (nymphs+adults) per hill. Record the observations from 10 hills per plot. Calculate the percentage of BPH control.

$$\% Hoppers ( BPH ) control = 100 - \frac{Number of live BPH in treated plot}{Number of live BPH in untreated plot} \times 100$$

TABLE 14
BPH control in rice crop

| | gram actives | Rice BPH control (%) at 7 DAA | | | |
|---|---|---|---|---|---|
| | ingredients | control | control | Colby's | Synergism |
| Treatment compositions | per hectare | observed | expected | ratio | (Y/N) |
| T1-Fluxametamide | 30 + 100 + 20 | 96.4 | 84.8 | 1.14 | Y |
| 12% + Pymetrozine | | | | | |
| 40% + Zinc lactate | | | | | |
| gluconate 8% WG | | | | | |
| T2-Fluxametamide | 30 + 20 + 20 | 98.8 | 86.3 | 1.15 | Y |
| 6% + Triflumezopyrim | | | | | |
| 4% + Zinc lactate gluconate | | | | | |
| 4% SC | | | | | |
| T3-Fluxametamide | 30 + 80 + 20 | 95.2 | 83.1 | 1.15 | Y |
| 3% + Flupyrimin 8% + Zinc | | | | | |
| lactate gluconate 2% SC | | | | | |
| T4-Fluxametamide | 30 + 120 + 40 | 97.2 | 85.6 | 1.14 | Y |
| 3% + Tolfenpyrad | | | | | |
| 12% + Zinc lactate | | | | | |
| gluconate 2% SC | | | | | |
| T5-Fluxametamide 10% EC | 30 | 52.8 | | | |
| T6-Zinc lactate gluconate | 20 | 8.4 | | | |
| 24% WP | | | | | |
| T7-Pymetrozine 50% WG | 100 | 64.8 | | | |
| T8-Triflumezopyrim 10% SC | 20 | 68.2 | | | |
| T9-Flupyrimin 10% SC | 80 | 60.8 | | | |
| T10-Tolfenpyrad 15% EC | 120 | 66.6 | | | |
| T11-Untreated Check | — | 0.0 | | | |
| (UTC) | | | | | |

All the present compositions (T1 to T4) provide synergistic control of BPH infesting rice crop and T5-T10 are market products.

Conclusion: Among the various compositions as shown in Table 14 treatment numbers T1-T4 are considered to be present inventive compositions which showed excellent synergism and effectiveness against BPH (Brown Plant Hopper) in rice. Treatment number T1-T4 showed more than 95.2% control on BPH in rice plant at 7 DAA (days after application). In particular, T2 showed (98.8%) followed by T4 (97.2%) and T1 (96.4%) of control on BPH in rice plant as compared to other products. Moreover, the colby's ratio was found to be >1 for the present compositions T1-T4 which shows effective synergism.

### Example 8: Larval Control in Marigold

Crop: Marigold
Location: Umreth, Gujarat
Treatments: 13
Spray water volume: 400 liter per hectare
Method of application: Foliar spray with battery operated knapsack sprayer fitted with hollow cone nozzle.

### Observation Methods:

Larval (mixed infestation of Helicoverpa armigera and Spodoptera exigua) control (%): as given in example 3.

TABLE 15
Larval control in marigold (infesting flowers and foliage)

| | gram actives | Larval control (%) at 7 DAA | | | |
|---|---|---|---|---|---|
| | ingredients | control | control | Colby's | Synergism |
| Treatment compositions | per hectare | observed | expected | ratio | (Y/N) |
| T1-Fluxametamide | 32 + 8 + 20 | 99.4 | 89.9 | 1.11 | Y |
| 8% + Emamectin benzoate | | | | | |
| 2% + Ascophyllum nodosum | | | | | |
| extract 5% SC | | | | | |
| T2-Fluxametamide | 32 + 80 + 20 | 99.2 | 89.3 | 1.11 | Y |
| 8% + Methoxyfenozide | | | | | |
| 20% + Ascophyllum nodosum | | | | | |
| extract 5% SC | | | | | |
| T3-Fluxametamide | 32 + 48 + 20 | 100.0 | 91.1 | 1.10 | Y |
| 8% + Spinosad | | | | | |
| 12% + Ascophyllum nodosum | | | | | |
| extract 5% SC | | | | | |
| T4-Fluxametamide | 32 + 32 + 20 | 100.0 | 90.5 | 1.10 | Y |
| 8% + Spinetoram | | | | | |
| 8% + Ascophyllum nodosum | | | | | |
| extract 5% SC | | | | | |
| T5-Fluxametamide | 32 + 40 + 20 | 100.0 | 91.9 | 1.09 | Y |
| 8% + Indoxacarb | | | | | |
| 10% + Ascophyllum nodosum | | | | | |
| extract 5% SC | | | | | |
| T6-Fluxametamide 10% EC | 32 | 74.2 | | | |
| T7-Ascophyllum nodosum | 20 | 1.6 | | | |
| extract 95% L | | | | | |
| T8-Emamectin benzoate 1.9% EC | 8 | 60.2 | | | |
| T9-Methoxyfenozide 24% SC | 80 | 57.8 | | | |
| T10-Spinosad 45% SC | 48 | 64.8 | | | |
| T11-Spinetoram 21.7% SC | 32 | 62.6 | | | |
| T12-Indoxacarb 15% SC | 40 | 68.2 | | | |
| T13-Untreated Check (UTC) | — | 0.0 | | | |

All the present compositions (T1 to T5) provide synergistic control of larvae infesting marigold flowers and foliage. Further visual observations showed excellent larval control up to 21 days after application, with an excellent flower quality.

Conclusion: Among the various compositions as shown in Table 15 treatment number T1-T5 are considered to be present inventive compositions which showed more than 99.2% larval control at 7 DAA (days after application) which showed an excellent synergism and effectiveness against larval (mixed infestation of Helicoverpa armigera and Spodoptera exigua) control in marigold. Particularly, T3, T4 and T5 proved 100% of larval control in marigold at 7 DAA and the colby's ratio depicted >1 proving effective synergism when compared with other products.

### Overall Field Trials Summery:

The innovative compositions comprising of fluxametamide, at least one insecticide and at least one plant health additive provides synergism in terms of insect-pests control, residual control, produces more fruits, flowers and grains, increases spectrum of control, reduces number of pesticidal applications under field conditions.

More particularly, the present invention also refers to the below mentioned preferred components:
Fluxametamide 5%+Lambda cyhalothrin 5%+Gibberellic acid 0.2% EC
Fluxametamide 5%+Bifenthrin 8%+Gibberellic acid 0.2% SC
Fluxametamide 5%+Fenpropathrin 10%+Gibberellic acid 0.2% EC
Fluxametamide 5%+Deltamethrin 2%+Gibberellic acid 0.2% EC
Fluxametamide 5%+Cypermethrin 6%+Gibberellic acid 0.2% EC
Fluxametamide 6%+Abamectin 1.8%+Gibberellic acid 0.4% EC
Fluxametamide 3%+Tolfenpyrad 12%+Gibberellic acid 0.2% SC
Fluxametamide 6%+Fipronil 9%+Gibberellic acid 0.4% SC
Fluxametamide 6%+Dimpropyridaz 9%+Gibberellic acid 0.4% SC
Fluxametamide 6%+Isocycloseram 6%+Gibberellic acid 0.4% SC
Fluxametamide 4%+Emamectin benzoate 1.8%+Fulvic acid 1% SC
Fluxametamide 4%+Methoxyfenozide 18%+Fulvic acid 1% SC
Fluxametamide 4%+Spinosad 10%+Fulvic acid 1% SC
Fluxametamide 4%+Spinetoram 8%+Fulvic acid 1% SC
Fluxametamide 4%+Indoxacarb 10%+Fulvic acid 1% SC
Fluxametamide 10%+Fenpyroximate 5%+Amino acid 2% SC
Fluxametamide 6%+Hexythiazox 4%+Amino acid 1.2% SC
Fluxametamide 6%+Etoxazole 5%+Amino acid 1.2% SC
Fluxametamide 3%+Diafenthiuron 25%+Amino acid 0.6% SC
Fluxametamide 6%+Azadirachtin 1%+Amino acid 1.2% EC
Fluxametamide 7%+Pyrifluquinazon 12%+Ortho silicic acid 2% SC
Fluxametamide 7%+Afidopyropen 7%+Ortho silicic acid 2% OD
Fluxametamide 7%+Flonicamid 8%+Ortho silicic acid 2% WG
Fluxametamide 3.5%+Pyriproxyfen 7%+Ortho silicic acid 1% EC
Fluxametamide 5%+Spirotetramat 10%+Paclobutrazol 5% OD
Fluxametamide 5%+Spirodiclofen 12%+Paclobutrazol 5% OD
Fluxametamide 2.5%+Spiromesifen 10%+Paclobutrazol 2.5% SC
Fluxametamide 5%+Spiropidion 8%+Paclobutrazol 5% SC
Fluxametamide 12%+Pymetrozine 40%+Zinc lactate gluconate 8% WG
Fluxametamide 6%+Triflumezopyrim 4%+Zinc lactate gluconate 4% SC
Fluxametamide 3%+Flupyrimin 8%+Zinc lactate gluconate 2% SC
Fluxametamide 3%+Tolfenpyrad 12%+Zinc lactate gluconate 2% SC
Fluxametamide 8%+Emamectin benzoate 2%+Ascophyllum nodosum extract 5% SC
Fluxametamide 8%+Methoxyfenozide 20%+Ascophyllum nodosum extract 5% SC
Fluxametamide 8%+Spinosad 12%+Ascophyllum nodosum extract 5% SC
Fluxametamide 8%+Spinetoram 8%+Ascophyllum nodosum extract 5% SC
Fluxametamide 8%+Indoxacarb 10%+Ascophyllum nodosum extract 5% SC

The process for preparing the present novel synergistic composition can be modified accordingly by any person skilled in the art based on the knowledge of the manufacturing the formulation. However, all such variation and modification is still covered by the scope of present invention.

Application to the seeds is carried out before sowing, either directly on the seeds or after having pregerminated the latter. Suitable application methods include inter alia soil treatment, seed treatment, in furrow application, and foliar application. Soil treatment methods include drenching the soil, drip irrigation (drip application onto the soil), dipping roots, tubers or bulbs, or soil injection. Seed treatment techniques include seed dressing, seed coating, seed dusting, seed soaking, and seed pelleting. In furrow applications typically include the steps of making a furrow in cultivated land, seeding the furrow with seeds, applying the insecticidally active composition to the furrow, and closing the furrow. Foliar application refers to the application of the insecticidally active composition to plant foliage, e.g. through spray equipment.

The rates of application vary within wide limits and depend on the nature of the soil, the method of application, the crop plant, the pest to be controlled, the prevailing climatic conditions, and other factors governed by the method of application, the time of application and the target crop.

The lists of crops on which the insecticidal composition of the present invention is used include, but not limited to GMO (Genetically Modified Organism) and Non GMO traits, hybrids and conventional varieties of Cotton (Gossypium spp.), Paddy (Oryza sativa), Wheat (Triticum aestavum), Barley (Hordeum vulgare), Maize (Zea mays), Sorghum (Sorghum bicolor), Oat (Avena sativa), Pearl millet (Pennisetum glaucum), Sugarcane (Saccharum officinarum), Sugarbeet (Beta vulgaris), Soybean (Glycin max), Groundnut/Peanut (Arachis hypogaea), Sunflower (Helianthus annuus), Mustard (Brassica juncea), Rape seed (Brassica napus), Sesame (Sesamum indicum), Green gram (Vigna radiata), Black gram (Vigna mungo), Chickpea (Cicer aritinum), Cowpea (Vigna unguiculata), Red gram (Cajanus cajan), French bean (Phaseolus vulgaris), Indian bean (Lablab purpureus), Horse gram (Macrotyloma uniflorum), Field pea (Pisum sativum), Cluster bean (Cyamopsis tetragonoloba), Lentils (Lens culinaris), Brinjal (Solanum melongena), Cabbage (Brassica oleracea var. capitata), Cauliflower (Brassica oleracea var. botrytis), Okra (Abelmoschus esculentus), Onion (Allium cepa L.), Tomato (Solanum lycopersicun), Potato (Solanum tuberosum), Sweet potato (Ipomoea batatas), Chilly (Capsicum annum), Bell pepper (Capsicum annum), Garlic (Allium sativum), Cucumber (Cucumis sativus), Muskmelons (Cucumis melo), Watermelon (Citrullus lanatus), Bottle gourd (Lagenaria siceraria), Bitter gourd (Momordica charantia), Radish (Raphanus sativus), Carrot (Dacus carota subsp. sativus), Turnip (Brassica rapa rapa), Apple (Melus domestica), Banana (Musa spp.), Citrus groups (Citrus spp.), Grape (Vitis vinifera), Guava (Psidium guajava), Mango (Mangifera indica), Papaya (Carica papaya), Pineapple (Ananas comosus), Pomegranate (Punica granatum), Sapota (Manilkara zapota), Tea (Camellia sinensis), Coffee (Coffea Arabica), Turmeric (Curcuma longa), Ginger (Zingiber officinale), Cumin (Cuminum cyminum), Black Pepper (Piper nigrum), Mentha (Mentha spp.), Rose (Rosa spp.), Jasmine (Jasminum spp.), Marigold (Tagetes spp.), Common daisy (Bellis perennis), Dahlia (Dahlia hortnesis), Gerbera (Gerbera jamesonii), and Carnation (Dianthus caryophyllus).

Crops are to be understood as also including those crops which have been rendered tolerant to herbicides or classes of herbicides (e.g. ALS-, GS-, EPSPS-, PPO-, ACCase- and HPPD-inhibitors) by conventional methods of breeding or by genetic engineering. An example of a crop that has been rendered tolerant to imidazolinones, e.g. imazamox, by conventional methods of breeding is Clearfield® summer rape (canola). Crops that have been rendered tolerant to herbicides by genetic engineering methods include, but not limited to, glyphosate- and glufosinate-resistant maize varieties commercially available under the trade names RoundupReady® and LibertyLink®.

Crops are also to be understood as being those which have been rendered resistant to harmful insects by genetic engineering methods, for example Bt maize (resistant to European corn borer), Bt cotton (resistant to cotton boll weevil) and also Bt potatoes (resistant to Colorado beetle). Bt maize incudes Bt 176 maize hybrids of NK® (Syngenta Seeds). The Bt toxin is a protein that is formed naturally by Bacillus thuringiensis soil bacteria. EP-A-451 878, EP-A-374 753, WO 93/07278, WO 95/34656, WO 03/052073 and EP-A-427 529 describe such toxins or transgenic plants able to synthesize such toxins. Transgenic plants comprising one or more genes that code for an insecticidal resistance and express one or more toxins are KnockOut® (maize), Yield Gard® (maize), NuCOTIN33B® (cotton), Bollgard® (cotton), NewLeaf® (potatoes), NatureGard® and Protexcta®. Plant crops or seed material thereof can be both resistant to herbicides and, at the same time, resistant to insect feeding (“stacked” transgenic events). For example, seed can have the ability to express an insecticidal Cry3 protein while at the same time being tolerant to glyphosate.

Crops are also to be understood to include those which are obtained by conventional methods of breeding or genetic engineering and contain so-called output traits (e.g. improved storage stability, higher nutritional value and improved flavor).

Other useful plants include turf grass for example in golf-courses, lawns, parks and roadsides, or grown commercially for sod and ornamental plants such as flowers or bushes.

The insecticidal composition of the present invention can be used to control the insects-pests and plant parasitic nematode. The major insects-pests belong to the order Hemiptera, for example, but not limited to rice leafhopper/green leaf hopper (GLH) (Nephotettix nigropictus), rice brown plant hopper (BPH) (Nilaparvata lugen), rice backed plant hopper (WBPH) (Sogatella furcifera), Apple Mealy bug (Phenococcus aceris), bean aphid (Aphis fabae), black citrus aphid (Toxoptera aurantii), citrus black scale (Saissetia oleae), cabbage aphid (Brevicoryne brassicae), (Lipaphis erysimi), citrus red scale (Aonidiella aurantii), yellow scale (Aonidiella citrine), citrus mealybug (Planococcus citri), corn leaf aphid (Rhopalosiphum maidis), aphid (Aphis gossypii), jassid (Amrasca biguttula), mealy bug (Planococcus spp. and Pseudococcus spp.), cotton stainer (Dysdercus suturellus), whitefly (Bemisia tabaci), cowpea aphid (Aphis crassivora), grain aphid (Sitobion avenae), golden glow aphid (Uroleucon spp.), grape mealybug (Pseudococcus maritimus), green peach aphid (Myzus persicae), greenhouse whitefly (Trialeurodes vaporariorum), papaya mealy bug (Pracoccus marginatus), pea aphid (Acyrthosiphon pisum), sugarcane mealybug (Saccharicoccus sacchari), potato aphid (Myzus persicae), potato leaf hopper (Empoasca fabae), cotton whitefly (Bemisia tabaci), tarnished plant bug (Lygus lineolaris), wooly apple aphid (Eriosoma lanigerum), and mango hopper (Amritodus atkinsoni, Idioscopus spp.); order Lepidoptera, for example, but not limited to army worm (Mythimna unipuncta), asiatic rice borer (Chilo suppressalis), bean pod borer (Maruca vitrata), beet armyworm (Spodoptera exigua), black cutworm (Agrotis ipsilon), bollworm (Helicoverpa armigera), cabbage looper (Trichoplusia ni), codling moth (Cydia pomonella), croton caterpillar (Achea janata), diamond backmoth (Plutella xylostella), cabbage worm (Pieris rapae), pink bollworm (Pectinophora gossypiella), sugarcane borer (Diatraea saccharalis), sugarcane early shoot borer (Chilo infuscatellus) tobacco budworm (Heliothis virescens), tomato fruitworm (Helicoverpa zea), velvet bean caterpillar (Anticarsia gemmatalis), yellow stem borer (Scirpophaga incertulas), spotted bollworm (Earias vittella), rice leaf-folder (Cnaphalocrocis medinalis), pink stem borer (Sesamia spp.), tobacco leaf-eating caterpillar (Spodoptera litura); brinjal fruit and shoot borer (Leucinodes orbonalis), bean pod borer (Maruca vitrata, Maruca testulalis), armyworm (Mythimna separata), citrus leaf-miner (Phyllocnistis citrella), cabbage butterfly (Pieris brassicae), paddy stem borer (Scirpophaga excerptallis, Scirpophaga incertulas, Scirpophaga innotata), wheat stem borer (Sesamia inferens, Sitotroga cerealella, Spilosoma obliqua), and fall armyworm (Spodoptera frugiperda, Spodoptera littoralis, Spodoptera litura, Tryporyza nivella, Tryporyza incertulas, Tuta absoluta); to the order Coleoptera, for example, but not limited to apple twig borer (Amphicerus spp.), corn root worm (Diabrotica virgifera), cucumber beetle (Diabrotica balteata), boll weevil (Anthonomus grandis), grape flea beetle (Altica chalybea), grape root worm (Fidia viticola), grape trunk borer (Clytoleptus albofasciatus), radish flea beetle (Phyllotreta armoraciae), maize weevil (Sitophilus zeamais), northern corn rootworm (Diabrotica barberi), rice water weevil (Lissorhoptrus oryzophilus, Anthonomus grandis, Bruchus lentis, Diabrotica semipunctata, a, Diabrotica virgifera, Dicladispa armigera, Epilachna varivestis), and various species of white grubs (Holotrichia bicolor, Holotrichia consanguinea, Holotrichia serrata, Leptinotarsa decemlineata, Phyllotreta chrysocephala, Popillia japonica); to the order Orthoptera, for example, but not limited to Gryllotalpa spp., Locusta spp., and Schistocerca spp.; to the order Thysanoptera, for example, but not limited to Frankliniella spp., Thrips palmi, Thrips tabaci and Scirtothrips dorsalis; termites (Isoptera), for example, but not limited to Calotermes flavicollis, Coptotermes formosanus, Heterotermes aureus, Leucotermes flavipes, Microtermes obesi, Odontotermes obesus, Reticulitermes flavipes, and Termes natalensis; to the order Heteroptera, for example, but not limited to Dysdercus spp., and Leptocorisa spp., to the order Hymenoptera, for example, but not limited to Solenopsis spp.; to the order Diptera, for example, but not limited to Antherigona soccata, Dacus spp., Liriomyza spp., and Melanagromyza spp., to the order Acarina, for example, Aceria mangiferae, Brevipalpus spp., Eriophyes spp., Oligonychus mangiferus, Oligonychus punicae, Panonychus citri, Panonychus ulmi, Polyphagotarsonemus latus, Tarsonemus spp., Tetranychus urticae, and Tetranychus cinnabarinus; plant parasitic nematodes for example, but not limited to root-knot nematodes (Meloidogyne incognita, Meloidogyne javanica and other Meloidogyne species); cyst nematodes (Globodera rostochiensis, Globodera pallida, Globodera tabacum and other Globodera species), (Heterodera avenae, Heterodera glycines, Heterodera schachtii, Heterodera trifolii, and other Heterodera species); seed gall nematodes (Anguina funesta, Anguina tritici and other Anguina species); stem and foliar nematodes (Aphelenchoides besseyi, Aphelen-choides fragariae, Aphelenchoides ritzemabosi and other Aphelenchoides species); sting nematodes (Belonolaimus longicaudatus and other Belonolaimus species); pine nematodes (Bursaphelenchus xylophilus and other Bursaphelenchus species); ring nematodes (Criconema species, Criconemella species, Criconemoides species, and Mesocriconema species); stem and bulb nematodes (Ditylenchus destructor, Ditylenchus dipsaci, Ditylenchus myceliophagus and other Ditylenchus species); awl nematodes (Dolichodorus species); spiral nematodes (Helicotylenchus dihystera, Helicotylenchus multicinctus and other Helicotylenchus species), (Rotylenchus robustus and other Rotylenchus species); sheath nematodes (Hemicycliophora species and Hemicriconemoides species; Hirshmanniella species; lance nematodes, Hoplolaimus columbus, Hoplolaimus galeatus and other Hoplolaimus species); false root-knot nematodes (Nacobbus aberrans and other Nacobbus species); needle nematodes (Longidorus elongates and other Longidorus species); pin nematodes (Paratylenchus species); lesion nematodes (Pratylenchus brachyurus, Pratylenchus coffeae, Pratylenchus curvitatus, Pratylenchus goodeyi, Pratylencus neglectus, Pratylenchus penetrans, Pratylenchus scribneri, Pratylenchus vulnus, Pratylenchus zeae and other Pratylenchus species), (Radinaphelenchus cocophilus and other Radinaphelenchus species); burrowing nematodes (Radopholus similis and other Radopholus species); reniform nematodes (Rotylenchulus reniformis and other Rotylenchulus species), (Scutellonema species); stubby root nematodes (Trichodorus primitivus and other Trichodorus species, Paratrichodorus minor and other Paratrichodorus species); stunt nematodes (Tylenchorhynchus claytoni, Tylenchorhynchus dubius and other Tylenchorhynchus species and Merlinius species); citrus nematodes (Tylenchulus semipenetrans and other Tylenchulus species); dagger nematodes (Xiphinema americanum, Xiphinema index, Xiphinema diversicaudatum and other Xiphinema species); and other plant parasitic nematode species.

Noteworthy, when the composition of present invention is applied, the health of a plant is increased independently of the insecticidal properties of the active ingredients used because the increase in health is not based upon the reduced pest pressure but instead on complex physiological and metabolic reactions which result for example in an activation of the plant's own natural defense system. As a result, the health of a plant is increased even in the absence of pest pressure. Accordingly, the health of a plant is increased both in the presence and absence of biotic or abiotic stress factors.

The above identified indicators for the health condition of a plant can be interdependent or they can result from each other. An increase in plant vigor, for example result in an increased yield and/or tolerance to abiotic or biotic stress. Increased yield can be characterized, among others, by the following improved properties of the plant: increased plant, weight, increased plant height, increased biomass such as higher overall fresh weight (FW), increased number of flowers per plant, higher grain yield, more tillers or side shoots (branches), larger leaves, increased shoot growth, increased protein content, increased oil content, increased starch content, increased pigment content, increased leaf area index.

According to the present invention, the yield is increased by at least 4%, preferable by 5 to 10%, more preferable by 10 to 20%, or even 30 to 50% or even more, compared to the untreated control plants or plants treated with known conventional pesticides. In general, the yield increase can even be higher.

A further indicator for the condition of the plant is the plant vigor. The plant vigor becomes manifest in several aspects such as the general visual appearance. The plant vigor of the plants treated with the composition of present invention is increased synergistically. Improved plant vigor can be characterized, among others, by the following improved properties of the plant, such as, improved vitality of the plant, improved plant growth, improved plant development, improved visual appearance, improved plant stand (less plant verse/lodging), improved emergence, enhanced root growth and/or more developed root system, enhanced nodulation, in particular rhizobial nodulation, bigger leaf blade, bigger size, increased plant weight, increased plant height, increased tiller number, increased number of side shoots, increased number of flowers per plant, increased shoot growth, increased root growth (extensive root system), increased yield when grown on poor soils or unfavorable climate, enhanced photosynthetic activity (e.g. based on increased stomatal conductance and/or increased CO₂ assimilation rate), increased stomatal conductance, increased CO₂ assimilation rate, enhanced pigment content (e.g. chlorophyll content), earlier flowering, earlier fruiting, earlier and improved germination, earlier grain maturity, improved self-defense mechanisms, improved stress tolerance and resistance of the plants against biotic and abiotic stress factors such as fungi, bacteria, viruses, insects, heat stress, cold stress, drought stress, UV stress and/or salt stress, less non-productive tillers, less dead basal leaves, less input needed (such as fertilizers or water), greener leaves, complete maturation under shortened vegetation periods, less fertilizers needed, less seeds needed, easier harvesting, faster and more uniform ripening, longer shelf-life, longer panicles, delay of senescence, stronger and/or more productive tillers, better extractability of ingredients, improved quality of seeds (for being seeded in the following seasons for seed production), better nitrogen uptake, improved reproduction, reduced production of ethylene and/or the inhibition of its reception by the plant.

The improvement of the plant vigor according to the present invention particularly means that the improvement of any one or several or all of the above mentioned plant characteristics are improved independently of the insecticidal action of the mixture or active ingredients (components).

Another indicator for the condition of the plant is the “quality” of a plant and/or its products. The quality of the plants treated with the composition of present invention, is increased synergistically.

According to the present invention, enhanced quality means that certain plant characteristics such as the content or composition of certain ingredients are increased or improved by a measurable or noticeable amount over the same factor of the plant produced under the same conditions, but without the application of the composition of present invention. Enhanced quality can be characterized, among others, by the following improved properties of the plant or its product, such as, increased nutrient content, increased protein content, increased content of fatty acids, increased metabolite content, increased carotenoid content, increased sugar content, increased amount of essential amino acids, improved nutrient composition, improved protein composition, improved composition of fatty acids, improved metabolite composition, improved carotenoid composition, improved sugar composition, improved amino acids composition, improved or optimal fruit color, improved leaf color, higher storage capacity, higher processability of the harvested products.

Another indicator for the condition of the plant is the plant's tolerance or resistance to biotic and/or abiotic stress factors. Biotic and abiotic stress, especially over longer terms, can have harmful effects on plants. Biotic stress is caused by living organisms while abiotic stress is caused for example by environmental extremes. According to the present invention, “enhanced tolerance or resistance to biotic and/or abiotic stress factors” means (1.) that certain negative factors caused by biotic and/or abiotic stress are diminished in a measurable or noticeable amount as compared to plants exposed to the same conditions, but without being treated with the composition of present invention and (2.) that the negative effects are not diminished by a direct action of the composition of present invention on the stress factors, e.g. by its insecticidal action which directly destroys the microorganisms or pests, but rather by a stimulation of the plants' own defensive reactions against said stress factors.

The composition of present invention provides a number of benefits, such as, synergistic control of insect-pests and mites with one shot application; residual control i.e. longer duration of control with immediate crop protection; delay in development of resistance and effective control of hard to kill and resistant insect-pests and mites; increase in yield of treated plants (cereals, pulses, oilseeds, fibre crop, sugar crops, leafy vegetables, tuber crops, fruit crops, flowers, ornamentals etc.); increase in yield due to protection against insect-pests and mites; increase in yield due to plant growth regulation, increase in reproductive parts of plant; increase in yield due to more number of tillers, more branches and sub branches, more number of flowers, more number of fruits; increase plant vigor; increase tolerance to insect-pests and mite damage; increase tolerance to the weather stress and moisture stress; prevents lodging in susceptible plants due to biotic and abiotic factors, like heavy rains, winds, insects and diseases damage; improves quality (means visual appearance, color, size, shape etc.) in grains, fruits, fiber, flowers, tuber, bulb, rhizomes, straw, leaves and other plant parts and plant products; improves keeping quality of produce, increase post harvest life, storage life, protection from post harvest diseases; uniform sizing in tuber, bulb, rhizome and root crops.

The present invention has been described with reference to specific embodiment which is merely illustrative and not intended to limit the scope of the invention as defined in the present complete specification.

1. A fluxametamide composition comprising:
A) fluxametamide in an amount of 1 to 40 w/w %;
B) at least one or more insecticide selected from the group consisting of lambda cyhalothrin, bifenthrin, fenpropathrin, deltamethrin, cypermethrin, abamectin, tolfenpyrad, fipronil, dimpropyridaz, isocycloseram, emamectin benzoate, methoxyfenozide, spinosad, spinetoram, indoxacarb, fenpyroximate, hexythiazox, etoxazole, diafenthiuron, azadirachtin, pyrifluquinazon, afidopyropen, flonicamid, pyriproxyfen, spirotetramat, spirodiclofen, spiromesifen, spiropidion, pymetrozine, triflumezopyrim and flupyrimin in an amount of 1 to 40 w/w %; and
C) at least one or more plant health additive selected from group consisting of gibberellic acid, fulvic acid, amino acid, ortho silicic acid, paclobutrazol, zinc lactate gluconate, Ascophyllum nodosum extract in an amount of 0.001 to 20 w/w % and agrochemically acceptable excipients.

2. The fluxametamide composition as claimed in claim 2 wherein, more preferably the insecticide(s) of compound B are present in the range of 1% to 40%.

3. The fluxametamide composition as claimed in claim 4 wherein, the amino acids for compound C is selected from alanine, arginine, aspartic acid, cysteine, glutamic acid, glycine, histidine, isoleucine, leucine, lysine, methionine, phenylalanine, proline, serine, threonine, tryptophan, tyrosine, valine and mixture thereof.

4. The fluxametamide composition as claimed in claim 4 wherein, more preferably the plant health additive(s) of compound C are present in the range of 0.2% to 8%.

5. The fluxametamide composition as claimed in claim 1, wherein the agrochemically acceptable excipients are selected from the group consisting of dispersing agents, anti-freezing agent, anti-foam agent, wetting agents, suspension aid and carriers, anti-microbial agent, thickener, colorants, quick coating agent or sticking agents, polymers, disintegrating agent, oil additive, buffering agent, and solvents.

6. The fluxametamide composition as claimed in claim 6, wherein the agrochemically acceptable excipients are present in the range from 0.1% to 99% of the total weight of the composition.

7. The fluxametamide composition as claimed in claim 1, wherein the composition is in the form of oil dispersion (OD), wettable granule (WG), emulsifiable concentrate (EC) and suspension concentrate (SC).

8. The fluxametamide composition as claimed in claim 1, wherein the wetting agent for oil dispersion (OD) is selected from the group consisting of ethylene oxide/propylene oxide block copolymer, polyarylphenyl ether phosphate, ethoxylated fatty alcohol, sodium dioctyl sulfosuccinate, sodium lauryl sulfate, sodium dodecyl benzene sulfonate, alkyldiphenyl sulfonates, sodium isopropyl naphthalene sulfonate, alkylnaphthalene sulfonate and mixture thereof.

9. The fluxametamide composition as claimed in claim 1, wherein the wetting-spreading-penetrating agent for oil dispersion (OD) is selected from the group consisting of organosilicone surfactants trisiloxane ethoxylate, polydimethylsiloxane, polyoxyethylene methyl polysiloxane, polyoxyalkylene methyl polysiloxane, polyether polymethyl siloxane copolymer, heptamethyl trisiloxane, polyalkyleneoxide modified heptamethyl trisiloxane, polyether modified polysiloxane, in unmodified form and mixture thereof.

10. The fluxametamide composition as claimed in claim 1, wherein the emulsifying agent for oil dispersion (OD) is selected from the group consisting of castor oil ethoxylates, alcohol ethoxylates, fatty acid ethoxylates, sorbitan ester ethoxylates, sulphosuccinate, calcium salts of dodecylbenzene sulphonate, alkylammonium salts of alkylbenzene sulphonate, alkylsulphosuccinate salts, ethylene oxide-propylene oxide block copolymers, ethoxylated alkylamines, ethoxylated alkyl phenols, polyoxyethylene sorbitan monolaurate and mixture thereof.

11. The fluxametamide composition as claimed in claim 1, wherein the dispersing agent for oil dispersion (OD) is selected from the group consisting of alkyl sulfonates, alkyl benzene sulfonates, alkyl aryl sulfonates, alkylphenolalkoxylates, tristyrylphenol ethoxylates, natural or synthetic fatty ethoxylate alcohols, natural or synthetic fatty acid alkoxylates, natural or synthetic fatty alcohols alkoxylates, alkoxylated alcohols, n-butyl alcohol poly glycol ether, block copolymers, ethylene oxide-propylene oxide block copolymers, ethylene oxide-butylene oxide block copolymers, fatty acid-polyalkylene glycol condensates, polyamine-fatty acid condensates, polyester condensates, salts of polyolefin condensates, sodium ligno sulfonate, sodium ploycarboxylate, EO/PO based copolymer, phenol sulfonate, sodium methyl oleoyl taurate, styrene acrylic acid copolymer, propyleneoxide-ethyleneoxide-copolymer, polyethylene glycol 2,4,6-tristyrylphenyl ether, tristyrylphenol-polyglycolether-phosphate, tristyrylphenole with 16 moles EO, tristyrylphenol-polyglycolether-phosphate, oleyl-polyglycolether with ethylene oxide, tallow fattyamine polyethylene oxide, nonylphenol polyglycolether with 9-10 moles ethylene oxide and mixture thereof.

12. The fluxametamide composition as claimed in claim 1, wherein the stabilizer for oil dispersion (OD) is selected from the group consisting of hectorite clay, aluminium magnesium silicate, bentonite clay, silica, attapulgite clay and mixture thereof.

13. The fluxametamide composition as claimed in claim 1, wherein the antifoaming agent for oil dispersion (OD) is selected from the group consisting of silicone oil, silicone compound, C₁₀˜C₂₀ saturated fat acid compounds or C₈˜C₁₀ aliphatic alcohols compound, silicone antifoam emulsion, dimethylsiloxane, polydimethyl siloxane, vegetable oil based antifoam, tallow based fatty acids, polyalkyleneoxide modified polydimethylsiloxane and mixture thereof.

14. The fluxametamide composition as claimed in claim 1, wherein the anti-freezing agent for oil dispersion (OD) is selected from the group consisting of ethylene glycol, propane diols, glycerine or the urea, glycol, monoethylene glycol, diethylene glycol, polypropylene glycol, polyethylene glycol, glycerine, urea, magnesium sulfate heptahydrate, sodium chloride and mixture thereof.

15. The fluxametamide composition as claimed in claim 1, wherein the preservative for oil dispersion (OD) is selected from the group consisting of 1,2-benzisothiazolin-3(2H)-one, sodium salt, sodium benzoate, 2-bromo-2-nitropropane-1,3-diol, formaldehyde, sodium o-phenylphenate, 5-chloro-2-methyl-4-isothiazolin-3-one, 2-methyl-4-isothiazolin-3-one and mixture thereof.

16. The fluxametamide composition as claimed in claim 1, wherein the solvent for oil dispersion (OD) is selected from the group consisting of vegetable oil (plant, seed or tree) or its alkylated or ethoxylated or esterified; the alkylated vegetable oil, methylated vegetable oil or ethylated vegetable oil; olive oil, kapok oil, castor oil, papaya oil, camellia oil, sesame oil, corn oil, rice bran oil, cotton seed oil, soybean oil, groundnut oil, rapeseed-mustard oil, linseed oil, tung oil, sunflower oil, safflower oil, coconut oil; methyl ester, ethyl ester, propyl ester or butyl ester of vegetable oils, methylated seed oil, polyalkyleneoxide modified polydimethylsiloxane alkylphenol ethoxylate, rapeseed oil methyl ester, rapeseed oil ethyl ester, rapeseed oil propyl esters, rapeseed oil butyl esters, soybean oil methyl ester, soybean oil ethyl ester, soybean oil propyl ester, soybean oil butyl ester, castor oil methyl ester, castor oil ethyl ester, castor oil propyl ester, castor oil butyl ester, cotton seed oil methyl ester, cotton seed oil ethyl ester, cotton seed oil butyl ester, cotton seed oil propyl ester, tall oil fatty acids esters-tallow methyl ester, tallow ethyl ester, tallow propyl ester, bio-diesel, mineral oil, aromatic solvents, isoparaffin, base solvent, fatty acid amides, C₁-C₃ amines, alkylamines or alkanolamines with C₆-C₁₈ carboxylic acids, fatty acids, alkyl esters of fatty acids, methyl and ethyl oleate, methyl and ethyl soyate, alkyl benzenes, alkylnaphthalenes, polyalkylene glycol ethers, fatty acid diesters, fatty alkylamides, diamides, dialkylene carbonates, ketones, alcohols and mixture thereof.

17. The fluxametamide composition as claimed in claim 1, wherein the cosolvent for oil dispersion (OD) is selected from the group consisting of cyclohexanone, acetophenone, NMP, dimethyl sulfoxide, benzyl alcohol, butanol, N-octanol, N-propanol, 2-ethyl hexanol, tetrahydro furfuryl alcohol, isophorone, fatty acid dimethyl amide, 2-hexylethyl lactate, propylene carbonate and mixture thereof.

18. The fluxametamide composition as claimed in claim 1, wherein the dispersing agent for wettable granule (WG) is selected from the group consisting of sodium polycarboxylate, sodium polyacrylate, naphthalene sulfonic acid, sodium salt condensates with formaldehyde, polyalcoxylated alkylphenol, naphthalene sulfonic acid formaldehyde condensate, methyl naphthalene-formaldehyde-condensate sodium salt, naphthalene condensates, lignosulfonates, calcium lignosulfonate, lignin sulfonate sodium salt, alkyl naphthalene sulfonate, sodium salt and mixture thereof.

19. The fluxametamide composition as claimed in claim 1, wherein the wetting agents for wettable granule (WG) is selected from the group consisting of sodium N-methyl-N-oleoyl taurate, alkylated naphthalene sulfonate, sodium salt, mixture of isomers of dibutyl naphthalene sulphonic acid sodium salt, sodium di-isopropyl naphthalene sulphonate, sodium lauryl sulfate, dioctyl sulfate, alkyl naphthalene sulfonates, phosphate esters, sulphosuccinates, non-ionic, tridecyl alcohol ethoxylate, alkyl or alkaryl sulfonates, alkylbenzene sulfonates, alpha olefin sulfonate, alkyl naphthalene sulfonates, ethoxylated or non-ethoxylated alkyl or alkaryl carboxylates, alkyl or alkaryl phosphate esters, alkyl polysaccharide, di or mono alkyl sulfosuccinate derivatives, alpha olefin sulfonates, alkyl naphthalene sulfonates, dialkyl sulphosuccinates, butyl, dibutyl, isopropyl, di-isopropyl naphthalene sulfonate salts, C₁₂ alkyl benzene sulfonate or C₁₀-C₁₆ alkyl benzene sulfonate, organosilicons surfactants, trisiloxane ethoxylate, polydimethylsiloxane, polyoxyethylene methyl polysiloxane, polyoxyalkylene methyl polysiloxane, polyether polymethyl siloxane copolymer, trisiloxane heptamethyl, polyalkyleneoxide modified heptamethyl trisiloxane, polyether modified polysiloxane, in unmodified form, and mixture thereof.

20. The fluxametamide composition as claimed in claim 1, wherein the antifoaming agent for wettable granule (WG) is polydimethylsiloxane.

21. The fluxametamide composition as claimed in claim 1, wherein the carrier for wettable granule (WG) is selected from the group consisting of china clay, silica, lactose anhydrous, ammonium sulfate, sodium sulfate anhydrous, corn starch, urea, EDTA, urea formaldehyde resin, diatomaceous earth, kaolin, bentonite, kieselguhr, fuller's earth, attapulgite clay, bole, loess, talc, chalk, dolomite, limestone, lime, calcium carbonate, powdered magnesia, magnesium oxide, magnesium sulphate, sodium chloride, gypsum, calcium sulphate, pyrophyllite, silicates, silica gels, ammonium sulphate, ammonium phosphate, ammonium nitrate, urea, natural products of vegetable origin, grain meals, flours, bark meals, wood meals, nutshell meals, cellulosic powders, synthetic polymeric materials, ground or powdered plastics, resins, bentonites, zeolites, titanium dioxide, iron oxides, hydroxides, aluminium oxides, hydroxides or organic materials, bagasse, charcoal, or synthetic organic polymers and mixture thereof.

22. The fluxametamide composition as claimed in claim 1, wherein the humectant for wettable granule (WG) is selected from the group consisting of humic acid, glycerol, lactose, sodium sulphate anhydrous and mixture thereof.

23. The fluxametamide composition as claimed in claim 1, wherein the solvent for emulsifiable concentrate (EC) is selected from the group consisting of aromatic hydrocarbon, C-9, toluene, o-, m-, p-xylene, dodecane, n-decane, n-hexane, benzene, ethylbenzene, isopropylbenzene, tert-butylbenzene, naphthalenes, mono- or polyalkyl-substituted naphthalenes, heavy aromatic naphthalene depleted (aromatic 200, 100, 150), n-butanol, N-methyl 2-pyrrolidine, methanol, ethanol, n-propanol, isopropanol, n-butanol, tert-butanolparaffinic hydrocarbons, cyclohexanone, isophorone, ester solvents, methyloleate, dimethylamide and morpholineamide derivatives of C₆-C₁₆ fatty acids, mono-alkylene carbonates, ethylene carbonate, propylene carbonate, butylene carbonates, dimethylsulfoxide (DMSO), 2-ethylhexanol, n-butanol, n-alkylpyrrolidones, fatty acid dimethyl esters, fatty acid esters, dibasic esters, aromatic hydrocarbons aliphatic hydrocarbons, one or more dimethylamides, C₈-dimethylamide, C₁₀-dimethylamide, C₁₂-dimethylamide, ethylene glycol, propylene glycol, polyalkylene glycols, methylpyrrolidinone (NMP), N, N-decanamide, dimethylformamide (DMF), dimethylisosorbide (DMI), isophorone, acetophenone, 1,3-dimethyl-2-imidazolidonone, lactate esters, dimethyl and diethylcarbonates, alcohols, methanol, ethanol, iso-propanol, n-propanol, n-butanol, iso-butanol, tert-butanol, methyl L-lactate, 2-ethylhexyl L-lactate, ethyl L-lactate, n-butyl L-lactate, octyl phenyl ethoxylates and mixture thereof.

24. The fluxametamide composition as claimed in claim 1, wherein the emulsifier for emulsifiable concentrate (EC) is selected from the group consisting of emulsifiers containing salts of dodecylbenzene sulphonate, Ca-salts or amine salts, sulphonates of other C₁₁-C₁₆ alkylbenzenes, alkylether sulphates, alkylphenoletherphosphates, ester phosphates, non-ionic surfactants, alkoxylated alcohols, alkylphenols, ethoxylated fatty acids, ethoxylated vegetable oils, ethoxylated castor oil, fatty acid esters, sorbitol, ethoxylated derivatives of sorbitol, ethoxylated amines, condensates of glycerol, catanionic emulsifiers, cationic amine, alkylsulphonate, ether sulphonate, ether phosphate, alkoxylated alcohols, alkoxylated alkylphenols, ethoxylated fatty acids, ethoxylated vegetable oils, ethoxylated tristyrylphenol, fatty acid esters of sorbitol and ethoxylated derivatives thereof; ethoxylated amines, condensates of glycerol, sulfonated alkylbenzenes in the range C₁₁-C₁₆ and salts thereof; alkylether sulphates; alkyletherphosphates; alkylphenoletherphosphates; and combinations thereof; salts of phosphate esters of ethoxylated tristyrylphenol; salts of sulphated ethers of ethoxylated tristyrylphenol; cationic amine is in combination with alkylsulphonate, alkylethersulphonate, ether sulphate, or ether phosphate, alkyletherphosphate, nonylphenol polyethoxy ethanols, castor oil polyglycol ethers, polyadducts of ethylene oxide and polypropylene; tributyl phenoxy polyethoxy ethanol, octyl phenoxy polyethoxy ethanol, calcium alkyl benzene sulfonate sodium salt, polyarylphenyl anionic ether sulfate-ammonium salt and mixture thereof.

25. The fluxametamide composition as claimed in claim 1, wherein the sticker, surface tension reducer, binder for emulsifiable concentrate (EC) is polyvinylpyrrolidone.

26. The fluxametamide composition as claimed in claim 1, wherein the spreader, sticker, penetrant, surface tension reducer for emulsifiable concentrate (EC) is alkyl polyethylene glycol ether.

27. The fluxametamide composition as claimed in claim 1, wherein the super wetting-spreading-penetrating agent for emulsifiable concentrate (EC) is polyalkyleneoxide modified heptamethyltrisiloxane.

28. The fluxametamide composition as claimed in claim 1, wherein the wetting agent for suspension concentrate (SC) is selected from the group consisting of ethylene oxide/propylene oxide block copolymer, polyarylphenyl ether phosphate, polyalkoxylated butyl ether, ethoxylated fatty alcohol, sodium dioctyl sulfosuccinate, sodium lauryl sulfate, sodium dodecyl benzene sulfonate, alkyl diphenyl sulfonates, sodium isopropyl naphthalene sulfonate, alkyl naphthalene sulfonate, organosilicons surfactants, trisiloxane ethoxylate, polydimethylsiloxane, polyoxyethylene methyl polysiloxane, polyoxyalkylene methyl polysiloxane, polyether polymethyl siloxane copolymer, heptamethyl trisiloxane, polyalkyleneoxide modified heptamethyl trisiloxane, polyether modified polysiloxane, polyalkyleneoxide modified trisiloxane, polyalkyleneoxide modified polydimethylsiloxane, trisiloxane ethoxylate, polyoxyethylene methyl polysiloxane, polyether polymethyl siloxane copolymer, polyether modified polysiloxane; in unmodified form and mixture thereof.

29. The fluxametamide composition as claimed in claim 1, wherein the dispersing agent for suspension concentrate (SC) is selected from the group consisting of naphthalenesulfonic acid, sodium salt condensated with formaldehyde, alkylated naphthalene sulfonate, sodium salt, sodium salt of naphthalene sulfonate condensate, sodium ligno sulfonate, sodium polycarboxylate, EO/PO based copolymer, phenol sulfonate, sodium methyl oleoyl taurate, styrene acrylic acid copolymer, propylene oxide-ethylene oxide-copolymer, polyethylene glycol 2,4,6-tristyrylphenyl ether, tristyrylphenol-polyglycol ether-phosphate, tristyrylphenole with 16 moles EO, tristyrylphenol-polyglycol ether-phosphate, oleyl-polyglycol ether with ethylene oxide, tallow fatty amine polyethylene oxide, nonylphenol polyglycol ether with 9-10 moles ethylene oxide and mixture thereof.

30. The fluxametamide composition as claimed in claim 1, wherein the suspending agent for suspension concentrate (SC) is selected from the group consisting of aluminum magnesium silicate, bentonite clay, silica, attapulgite clay and mixture thereof.

31. The fluxametamide composition as claimed in claim 1, wherein the antifoaming agent for suspension concentrate (SC) is selected from the group consisting of silicone oil, silicone compound, C₁₀˜C₂₀ saturated fat acid compounds or C₈˜C₁₀ aliphatic alcohols compound, silicone antifoam emulsion, dimethyl siloxane, polydimethyl siloxane, vegetable oil based antifoam, tallow based fatty acids, polyalkyleneoxide modified polydimethylsiloxane and mixture thereof.

32. The fluxametamide composition as claimed in claim 1, wherein the anti-freezing agent for suspension concentrate (SC) is selected from the group consisting of ethylene glycol, propane diols, glycerin or the urea, glycol, monoethylene glycol, diethylene glycol, polypropylene glycol, polyethylene glycol, glycerin, urea, magnesium sulfate heptahydrate, sodium chloride and mixture thereof.

33. The fluxametamide composition as claimed in claim 1, wherein the preservatives for suspension concentrate (SC) is selected from the group consisting of 1,2-benzisothiazolin-3 (2H)-one, sodium salt, sodium benzoate, 2-bromo-2-nitropropane-1,3-diol, formaldehyde, sodium o-phenyl phenate, 5-chloro-2-methyl-4-isothiazolin-3-one, 2-methyl-4-isothiazolin-3-one and mixture thereof.

34. The fluxametamide composition as claimed in claim 1, wherein the thickeners for suspension concentrate (SC) is selected from the group consisting of xanthan gum, PVK, carboxymethyl celluloses, polyvinyl alcohols, gelatin, sodium carboxymethylcellulose, hydroxyethyl cellulose, sodium polyacrylate, modified starch, acacia gum and mixture thereof.

35. The fluxametamide composition as claimed in claim 1, wherein the humectant for suspension concentrate (SC) is selected from the group consisting of urea, humic acid, glycerol, lactose and mixture thereof.
